(19) United States
(12) Patent Application Publication
(10) Pub. No.: US 2016/0132198 A1
(43) Pub. Date: May 12, 2016

(54) GRAPHICAL USER INTERFACES PROVIDING PEOPLE RECOMMENDATION BASED ON ONE OR MORE SOCIAL NETWORKING SITES

(71) Applicant: EnterpriseJungle, Inc., Los Angeles, CA (US)

(72) Inventors: James SINCLAIR, Los Angeles, CA (US); Emma SINCLAIR, London (GB)

(21) Appl. No.: 14/937,756

(22) Filed: Nov. 10, 2015

Related U.S. Application Data
(60) Provisional application No. 62/077,462, filed on Nov. 10, 2014.
(60) Provisional application No. 62/077,458, filed on Nov. 10, 2014.
(60) Provisional application No. 62/077,453, filed on Nov. 10, 2014.

(51) Int. Cl. G06F 3/0482; G06F 3/0484; H04L 29/08

(52) U.S. Cl. CPC G06F 3/0482; H04L 67/306; G06F 3/04842

(57) ABSTRACT

A graphical user interface having a dashboard for people recommendation to a first user, including: a first section presenting a plurality of second users one at a time and a second section presenting a plurality of people searches one at time. The first section has: a first area showing a profile image of a corresponding user in the second users; a second area showing profile text information of the corresponding user; a third area showing profile matching information between the corresponding user and the first user; and at least one first user interface element selectable to change a selection of the corresponding user from the second users. The second section has: a fourth area showing a corresponding search in the plurality of people searches; and at least one second user interface element selectable to change a selection of the corresponding search from the plurality of people searches.

### RELATED APPLICATIONS

The present application claims the benefit of the filing dates of provisional U.S. Pat. App. Ser. Nos. 62/077,462, 62/077,458, and 62/077,453, all filed Nov. 10, 2014, the entire disclosures of which applications are hereby incorporated herein by reference.

### FIELD OF THE TECHNOLOGY

At least some embodiments disclosed herein relate to the presentation of documents and/or data and operator interfaces (e.g., graphical user interface) for users in a network in general, and more specifically, but no limited to the presentation of resources in the network.

### BACKGROUND

U.S. Pat. App. Pub. No. 2011/0145719, entitled “People Recommendation Indicator Method and Apparatus in a Social Networking Site”, discloses a user interface that uses indicators configured to make people recommendations to a user by showing the user relatedness and/or connectedness between the user and other people in a social networking site. The social network-relatedness may be determined based on an analysis of “friend” or “connection” records of the social-networking site, “friend of a friend” or “one degree of separation”, or similarity scores between pairs of users based on the number of words/terms/topics or other content the two users have in common The indicators graphically illustrate the recommendation scores and are presented in each pertinent screen view/page of the social networking site.

There are various techniques to match people in various online environments. For example, U.S. Pat. No. 8,458,195 discloses a system to identify similar users based on the identification of topics and indications of how strongly the users are associated with the topics. U.S. Pat. App. Pub. No. 2013/0311501 discloses a system to match people based on inferences of preferences from usage behaviors that include the explicit establishing of relationships, including directionally distinct relationships, by users. U.S. Pat. App. Pub. No. 2015/0230052 discloses a system to match people based on physical object. U.S. Pat. App. Pub. Nos. 2014/0082082 and 2011/0302208 discloses systems to match people based on mutual expressions of interest. U.S. Pat. App. Pub. No. 2015/0230052 discloses a system to match people based on location. U.S. Pat. No. 8,515,901 discloses a system that delivers reasons for the matching to the matched people. U.S. Pat. No. 8,515,901 discloses a system that matches people in response to a search request.

The above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 shows a people recommendation platform according to one embodiment.

FIG. 2 illustrates a data processing system according to one embodiment.

FIGS. 3-25 show user interfaces for people recommendation according to one embodiment.

FIG. 26 shows a method to improve people recommendation according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

At least some embodiments disclosed in the present application provide improved user interfaces to provide people recommendations. At least some of the techniques have been implemented in a product referred to as “EnterpriseJungle” or “EJ”.

One embodiment disclosed in the present application includes a people recommendation platform, which is a technology platform that can take any (or multiple) online community(ies), in any form, and understand the relationships those people currently have, what the relationships between those people might be, extract relationship data, context, trend, signal, separate implicit and explicit data, and thus provide services of value, such as:

(1) introducing people to each other who do not know each other yet but should;

(2) assembling teams or assets with knowledge for a particular query;

(3) using the aggregated data to provide deep analytics of the ecosystem in question and extract patterns within those relationships and that data to deliver “understanding”; and

(4) using relationships to extract and drive employees towards a goal, a platform (such as an Enterprise Social Network) or a community.

The people recommendation platform can be deployed on any ecosystem or community platform because it is software agnostic. Its commercial value is particularly notable when applied to internal Enterprise Social Networks (ESN) configured on intranets, where employees in mid to large size organizations, often geographically dispersed, have an ecosystem in place designed to enhance sharing, communication, collaboration and centralization. The people recommendation platform and its features can significantly enhance the value of the ESN to such an organization.

Such examples of enhanced value include:

(1) Global Address Books: Improved, informative central databases for employees to search others and see contact, hierarchy, project and personal data in one well informed, up to date location;

(2) SharePoint Centralization (Yammer, Dynamics, Foundation Server);

(3) Process Driven ESN Platforms (e.g., SuccessFactors, IBM First, Oracle Social, Salesforce): Large enterprise document, sales, marketing and other platforms that have ESN components (social functions) built into the core of business processes as opposed to a standalone intranet; and

(4) Independent ESN Platforms (e.g., Jive): Independent, standalone ESN platforms which may include 3rd party widgets and tie-ins but are not fundamentally a part of a business process or employee experience.

In one implementation, the people recommendation platform has a host/parasite relationship with an ecosystem or community platform.

When implemented on ESN platforms, the fundamental value of the people recommendation platform features to any organization and its parties and the benefit each of those parties receive includes the following.

The people recommendation platform provides the employees with the ability to harness a public, already populated network (e.g., LinkedIn) and synchronize their internal profile with an external one, resulting in a global employee profile that has a private component and a public component, and a better quality, factual address book for employees with augmented, informative data.

The people recommendation platform allows the employees to: source knowledge, get ‘there’ quick, and intelligently explore colleagues in the workforce and the value they may bring to a specific challenge, product or sales cycle.

The people recommendation platform provides the employees with the ability to ‘snoop’ on peers and co-workers and their activity. Activity within the intranet and connections made are highlighted on an internal feed. Based on information from publicized networks, the people recommendation platform provides the employees with the ability to monitor what others are doing and talking about to drive curiosity—a key motivation for employees to act—which leads to opportunity and productivity: Employees do not want to be left behind or be the last to know and the people recommendation platform feeds that curiosity to the benefit of all.

The people recommendation platform provides a tool for discovery: finding other data of value within the ESN that may not have been previously available or anticipated.

In one embodiment, the Friendship & Peers feature in the workplace supports employees happiness which in turn encourages greater productivity, drives efficiency and engenders passion in the workplace. Happy people benefit the bottom line.

The deployment of the people recommendation platform in ESN platforms can drive engagement, value and interest in an internal platform, whatever the motivation of the employee for doing so. The people recommendation platform provides data and improves understanding about the workforce, their communication methods and the tools they employ when seeking information—and what that information they are seeking may be. This has practical, strategic and financial value.

The deployment of the people recommendation platform in ESN can improve the return on the investments made in a collaborative work environment. Significant cash and time have been spent to support the concept of a more collaborative and communicative work culture. Despite this, adoption rates of ESNs by the workforce remain under 15%. Driving greater usage/adoption of the workforce via the people recommendation platform provides a better ROI.

The people recommendation platform provides tools and data for employee onboarding, succession planning, team building, performance reviews, human capital management and staff retention, etc. The people recommendation platform can be deployed to improve alignment with corporate core values, improve the ability to communicate with staff, provide predictive understanding of trends and opportunities in the workplace (attrition management), and lower attrition rates and improve employee satisfaction levels achieved through strong workplace peer relationships. It can provide financially beneficial (low staff turnover, internal promotions, low attrition) as well as beneficial for morale.

In one embodiment, the people recommendation platform is configured on top of communities that are a collective pool of data associated with entities/people in the communities, whether they are internal hierarchy data, project data, biographies, education, resume scraping, or other material data points. The people recommendation platform is configured to find the signals within it via computational analyses.

The people recommendation platform can be applied with similar protocols to email traffic, documents, bulletin boards and/or social sites, where the data coming in is analyzed in the same manner as any other data to provide value to the ecosystem.

(1) E-Mails. The people recommendation platform discovers the relationships among users from emails based on implicit relation information, such as how users write, communicate, the hours the users maintain, the speed of response (e.g. succinct, 80% reply within x minutes), etc., and explicit relation information, such as the people users are communicating with, their company and other houses data and in what manner (personal/business).

(2) Documents. The people recommendation platform discovers the relationships among users from documents based on what knowledge is contained in the document, what “data points” can be extracted and what companies, people, assets or topics does it relate to.

In one embodiment, a recommendations and tribal knowledge system is configured to provide conflict free and relatively simple entry into a corporate ecosystem. The value is measurable.

The people recommendation platform improves ecosystem value, by promoting a fully connected workforce, with no inherent risks of boundaryless data flow, e.g., knowing that Julie in Singapore is married to the VP of Marketing at the company the user want to pitch.

In one implementation, the people recommendation platform was implemented using the data set of a public social networking site, such as LinkedIn. A proof of concept website allows the people recommendation platform users to log in and access the functionality that can be created on any enterprise platform without having to undertake a pilot.

For example, in the implementation, when a user signs up to website for the first time, there is no work required to populate their profile. The people recommendation platform extracts their profile data from the public networking site, such as LinkedIn, including their photo and bio, network connections, status updates, bio modifications, groups and recommendations, and generate a ‘match score’ against other users.

In one embodiment, the people recommendation platform is implemented as a SaaS or OnPrem solution sitting atop of the ESN or other centralized authentication method that provides organizational data. For companies using SaaS, their existing platform can access the “app store” or extension pack of the platform and in a single click, the people recommendation platform can be installed and deployed on their private cloud platform. Simple settings and functions are controlled via the administration console however in general, the people recommendation platform is ‘plug and play’. An example of different settings might be that for traveling sales team, one increases the weighted value of proximity, but for a desk worker one increase the weighted value of likely knowledge in suggesting a recommendation.

In one embodiment, users receive a widget in their current ESN and can immediately interact using the functions created by the people recommendation platform directly within a white label format. The functions that can be undertaken with a user are correlated to that platform. Connecting could be via public networking site, such as LinkedIn, or via the internal address book; messaging is via internal chat functions and the data displayed for each user can not only include their ‘outside social profiles’ but, also the internal “private” data.

When users perform actions such as syncing their “MyProfile” on their internal platform to the public networking site, such as LinkedIn, or connecting with a recommendation, a “Feed” post is placed on the internal ESN wall alerting others in their ecosystem of their actions. This drives the viral loop, the curiosity functions and ultimately the deeper engagement—fear of missing out, curiosity about what others are doing, better and more regular interaction with the community in question.

In cases where the user is in an enterprise social network with private data, the people recommendation platform uses both private and public data for recommendation. In performing an “outside the company recommendation”, the people recommendation platform is configured to ignore explicit data in the private internal profile but maintain the implicit understanding of the user that may be derived at least in part using the private internal profile. An example for private data includes the hierarchical organizational data, employee ID, assistant's name, contact information and perhaps internal groups or interests that are restricted to people inside the firewall. If someone should not be privy to sensitive information, the people recommendation platform is configured to recognize that. The people recommendation platform can recognize whether an introduction has the credentials to see this private data and more importantly, re-engineer the scores based on this “allow” or not.

The people recommendation platform can also be implemented as SaaS products in Sharepoint & SuccessFactors environment.

Sharepoint is a document and ecosystem repository used by 85% of F1000 companies in some form. Built atop of the Sharepoint platform are integration using project management tools (e.g., Project Server), developer code management tools (e.g., foundation server), CRM management tools (e.g., Dynamics), and communications management tools (e.g., Lync), among others. These tools work together into a centralized dashboard. The people recommendation platform can be integrated into the Microsoft Azure platform and Sharepoint, allowing cloud companies to use just a single click to integrate the people recommendation platform functionalities into their ecosystem.

In one example, an admin would go to the Azure Marketplace and choose the people recommendation platform solution which would create a private cloud instance of the people recommendation platform functionality and deliver a widget or view on the SharePoint dashboard of the recommendations and tribal knowledge query. The integration allows users to link their data in a public networking site, such as LinkedIn, and augment their “My Profile” in ESN and would post this ecosystem data (feed) into Microsoft Yammer. The admin would have a back end console to view the analytics and management requirements or to set “rules” or “weights” in place for the recommendations.

As companies join the people recommendation platform and bring the private and public data of their employees into the people recommendation platform ecosystem, the people recommendation platform's understanding of the relationships and the value of the surplus of internal data held in the repository of the people recommendation platform become increasingly valuable.

The people recommendation platform may also provide User Interface (UI) in the form of mobile apps for mobile operating systems, such as iOS, Android and Blackberry. The mobile apps can use proximity data via GPS to find and alert to people within vicinity that the user should meet or connect with. Access can be provided via a public social network such as LinkedIn, or corporate social networking platforms, using their global login (OAUTH) functions.

In one embodiment, the people recommendation platform includes API configured to allow 3rd party applications to utilize the people recommendation platform functionality on their own datasets and/or white label applications.

In one embodiment, the people recommendation platform is implemented as a SuccessFactors/JAM extension on HCP. The solution provides employees with a real time feed of people, groups, content recommendations and team building queries likely to be of value.

In one embodiment, the people recommendation platform provides a social discovery service that utilizes the existing people-centric applications to provide real-time and context-sensitive people, content and group recommendations, and enterprise social network analytics. The people recommendation platform analyses implicit and explicit data, including profile and connections information, social posting and messaging data, to provide users with recommendations of internal groups, content or people who are similar to them or who might be relevant to their current project or activity, rich data and a picture of how the workforce is communicating and sharing information inside and outside the company walls, including highlights of areas needed attention, a knowledge base of expertise to help identify the best person to answer a specific query.

In one embodiment, the people recommendation platform is configured to enhance the profile of a user through integration with 3rd party data sources and network sync, bringing enriched user profiles to the internal network.

In one embodiment, the people recommendation platform is configured to use multiple data sources and enhanced intelligence to provide stronger and more relevant group, person, and activity recommendations.

In one embodiment, the people recommendation platform provides richer and dramatically enhanced user profiles, visibility into workforce social business graph and deep understanding of the relationship within the organization.

In one embodiment, the people recommendation platform provides a feature called ExpertConnect that redefines how one would look at, filter and access the workforce for topic experts, team building, sales enablement, and talent understanding. In one embodiment, it is implemented as part of the business process when the information is needed.

In one embodiment, the people recommendation platform provides actionable analytics of the workforce, their needs, and fingertip visual reporting of insights and knowledge of how they are collaborating, to support and build a stronger social enterprise.

The people recommendation platform can dramatic increase in adoption, retention, and usage of the enterprise network and the overall value and credibility of the platform. The people recommendation platform functionality can be accessible in as many platforms and channels as possible to further build the user base and technologies.

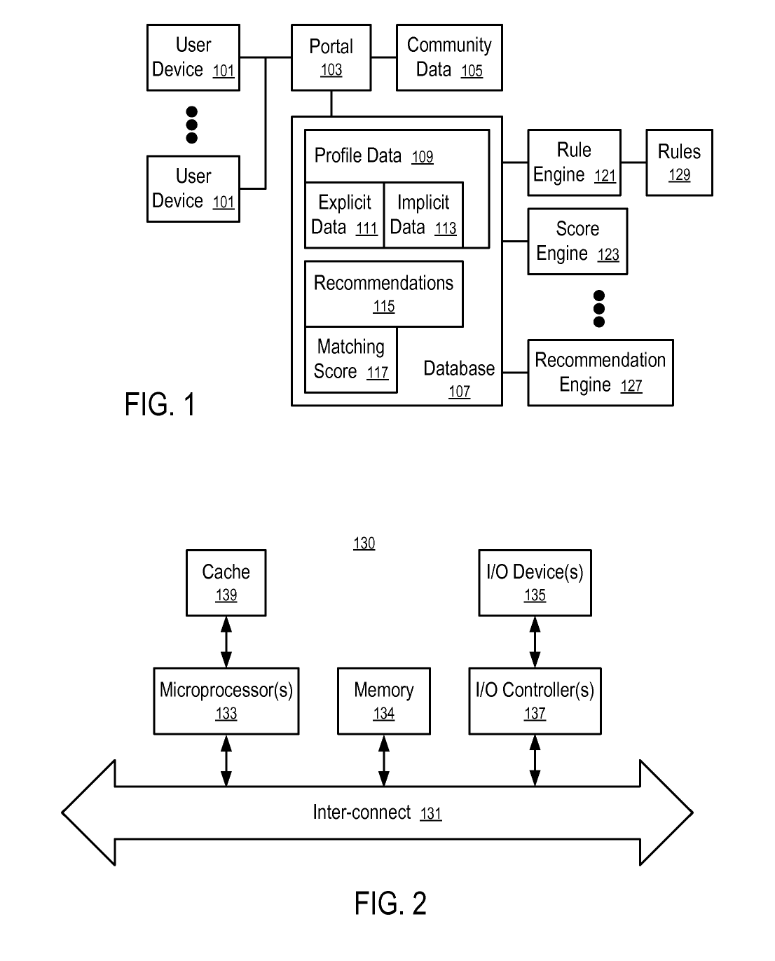

FIG. 1 shows a people recommendation platform according to one embodiment.

In FIG. 1, a portal (103) is configured to present an interface for user devices (101) to access the database (107) of the recommendation platform and/or the community data (105), such as a social networking site, an Enterprise Social Networks (ESN), or other data that includes community relationship, such as email traffic, documents, and bulletin boards.

In FIG. 1, a rule engine (121) is configured with a set of rules (129) to extract profile data (109) from the community data (105) and/or the input from the user devices (101).

In one embodiment, the profile data (109) includes explicit data (111) that are facts as stated by the users via the user devices (101) and/or found in the community data (105). The explicit data (111) of a user is presented to the user for verification, confirmation, correction, and/or update.

In one embodiment, the profile data (109) further include implicit data (113) that are derived by the rule engine (121) based on the explicit data (111) and the rules (129). In one embodiment, the implicit data (113) are not presented to users for verification or confirmation. In one embodiment, the human expert knowledge about users are coded via the rules to evaluate the implicit data (113) that represents subjective assertion of certain characteristics of the users which may or may not be true. In one embodiment, the assertions are statistically accurate and useful for identifying the relations among users, but direct user inputs on the subjective assertion may degrade the usefulness of the assertions in people recommendation. The assertions made via the rules (129) and the rule engine (121) can reduce the subjectiveness of the conclusion.

In FIG. 1, the score engine (123) is configured to generate, based on the profile data (109), a matching score (117) for recommending one user to another. In one embodiment, the matching score (117) is unsymmetric with respect to the users in that the matching score (117) for recommending user A to user B is generally different the matching score (117) for recommending user B to user A. A recommendation is based on both the matching score (117) for recommending user A to user B and the matching score (117) for recommending user B to user A, in order to determine whether or not to recommend user A to user B.

In FIG. 1, a recommendation engine (127) is configured to use the matching score (117) to generate and rank the recommendations (115) for presentation to users.

### Explicit Information

In one embodiment, the people recommendation platform provides explicit profile information about a user (e.g., facts the user has stated that the people recommendation platform take at face value).

A user actually provides the people recommendation platform with explicit information such as graduation year, interests, skills, work responsibilities, who they know, etc., so that the people recommendation platform can assign a score to that user based on what they have represented as fact. The score is a mixture of their profile completeness, the ability of the people recommendation platform to understand them, and the size of the social network of the user, charitable interests or any other certifications that validate their credibility.

What the user provided to the people recommendation platform is the first step towards a match score provided by the people recommendation platform. In one embodiment, the score is defined as that specific user as matched up against someone else. Thus, when the people recommendation platform is connecting two users, the score the people recommendation platform creates is only relevant to that one connection: user A's score for connection to user B and user B's score for connection to user A generally differ from user A's score for connection to user C and user C's score for connection to user A.

The people recommendation platform can include specific, explicit matches based on this data. For example, the matching can include the facts that users A and B both know 14 similar people, maintain 8 similar skills, are graduates of Yale, have an interest in CompSci, are both in a VP role at a company of similar value (VP of a 4 person company vs. VP of a F500 is an implicit undertaking) and so forth.

The people recommendation platform can present the information about the matching of the explicit information to the user, which makes logical sense to him or her, independent of whether they are a great match. Connecting people because they have surface commonality is common practice and natural to most users, despite it rarely being the mathematically best match.

### Implicit Information

In one embodiment, the people recommendation platform identifies implicit profile information of a user via a number of exercises to make some assumptions about the user including age and gender, exploring their choice of words (or lack of) and how they represent themselves (dark triad index).

In one embodiment, the people recommendation platform classifies users (e.g., using random forest algorithm) into groups of people who represent themselves in the same way. An example would be repeated use of “I” or “me” or people who use similar adjectives. If someone uses the word ‘aggressive’ in their bio, the people recommendation platform identifies the characteristic in classifying users into groups. This method of data sorting is undertaken, by the rule engine (121) based on the predetermined rules (129), without human input, seeking out “signals” and attempting to cluster them via statistical analysis.

For example, the people recommendation platform can estimate a user's current, past and future earnings based on their role and the skills they are likely to have to acquire to gain and maintain that role. This is not simply based on what the user has stated. The people recommendation platform looks at the career history and make assumptions about the characteristics of the user, such as:

Have they had the same job for 10 years?

In that 10 years, have they been promoted in a predetermined way?

Where do they sit in their organization's hierarchy in relation to their colleagues or others with similar experience, education and/or background?

Are they an 18 year old Head Of Marketing for a 2 person company selling lemonade on their street corner and still in college, —or is their title and representation backed with credible experience?

In one embodiment, the implicit profile information of a user represents the information the people recommendation platform calculated based on statistical analyses and/or rule based analyses as the people recommendation platform's understanding of the user. In one embodiment, the implicit profile information may not be facts and thus not presented to the user for update, correction, confirmation, and/or verification.

In one embodiment, the people recommendation platform uses the implicit information calculated for users to assign an implicit score to one user against another user and use ‘machine learning understanding’ to anticipate if the assumptions are correct and in aggregate, the types of people certain people like to connect with.

Some people will only connect “up the ladder”, for example, with people they perceive to be more senior. As the data pool increases, so too does the ability of the people recommendation platform to extract and make sense of these signals or commonalities. It allows for natural and instinctive matching to other people strengths.

For a given data set of people, the people recommendation platform can be configured to identify what is important. The people recommendation platform is configured via a set of algorithms to extract the known knowns and the unknown unknowns, where the people recommendation platform can set the output formats to reflect what we are looking to extract. The people recommendation platform can take the entire workforce and output various data sets, e.g., taking narcissism and correlate it to success and subsequently rank the index by city. In one embodiment, after receiving the terms (e.g., narcissism, success and city) as input, the people recommendation platform is configured to get an index and result.

### Matching Score

In one embodiment, the people recommendation platform uses both the explicit profile data and the implicit profile data in matching users for recommendation.

In one embodiment, the people recommendation platform creates an aggregate cosine score between any two users with an operation to ensure equilibrium against both users, aka the viewer and the recommendee. The recommendation is strong in both directions, i.e., the recommendee (e.g., you) need to be as valuable to the viewer (e.g., me) as the viewer (e.g. I) to the recommendee (e.g., you). For that to happen, the people recommendation platform is configured to be sufficiently intelligent to consider both parties. More data educates the people recommendation platform to make smarter recommendations. The people recommendation platform accumulates data with every new sign up so becomes an ever improving, more intelligent system over time.

Based on the data collected and/or computed by the people recommendation platform in a way discussed above, the people recommendation platform can provide the following features.

(1) Intra Company Recommendations: People in the ESN of the company the viewer should know but don't.

(2) Extra Company Recommendations: People not in the ESN of the company the viewer should know but don't. Imagine both of these as looking at a visual map of the network of the viewer and seeing obvious white spaces where people are missing. In one embodiment, finding people who make sense within the network sequence is the critical and key purposes of the people recommendation platform's intelligence.

(3) Feed showing the activity taking place in the ecosystem of the viewer; what connections of the viewer, be it 1st degree, groups, company, are doing or who they are connecting with. For example, if the viewer sees his/her boss just connected with person x, the viewer is more likely to click to see who person x is and think about how the viewer too can meet person x, in case the viewer is missing out on something or someone important.

(4) Tribal Knowledge Query: This is the ability to ask ‘the oracle’ a question and be presented with the people, team or resource most likely to help the viewer answer the question, maintain the knowledge or assist with the requirement within the community of the viewer. This spans a number of verticals including sales, HR and research. This can also be completed through a standard filter query which would present employees of an organization which the viewer could narrow down by adding supplemental filters such as (a) people who speak Japanese, (b) are in sales and (c) have worked or had dealings with Fujitsu. This could also be obtained by asking the oracle the question “Who is in sales, speaks Japanese and has a connection to Fujitsu?” Or the viewer could uses the user interface of the people recommendation platform to ask more direct questions such as “Working on a project for Fujitsu in Japanese” and possible include additional language such as “exclude employees of Fujitsu”.

In one embodiment, a user can now pursue a number of different actions via the people recommendation platform dashboard with the recommendations presented:

(1) Connect On a public social network such as LinkedIn;

(2) Message the recommendation;

(3) Refer the profile to someone else;

(4) Save the profile; and

(5) Based On Location: Schedule a coffee (e.g., in this instance, if both parties accept, the closest Starbucks is located at the central point of the two parties).

### User Interface

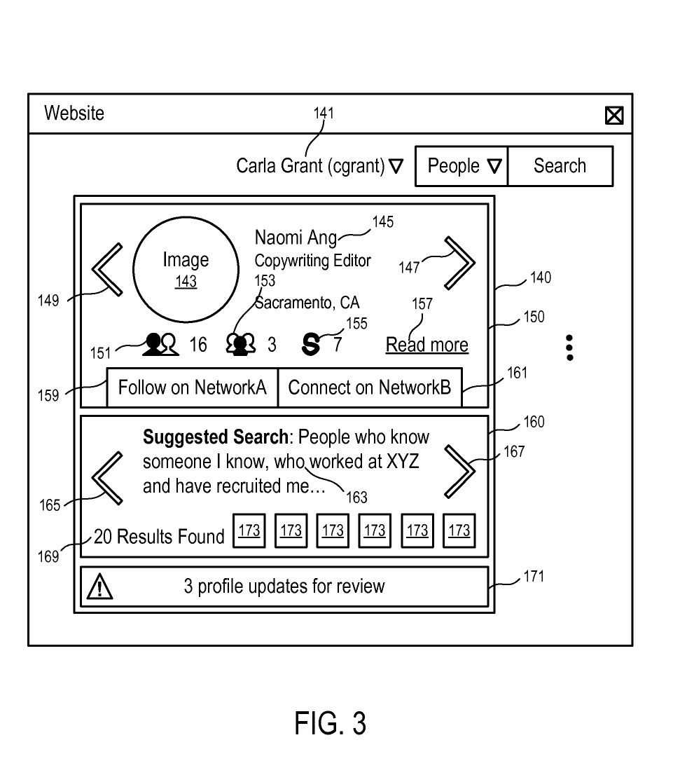

FIGS. 3-25 show user interfaces for people recommendation according to one embodiment.

In FIGS. 3-25, the people recommendation platform is implemented as a widget in an ESN platform (e.g., SuccessFactors) configured for a company.

In FIG. 3, the people recommendation platform has a dashboard (140) presented as a panel among the other panels of the ESN platform on a web page. After the user “Carla Grant” (141) signs in the system, the dashboard (140) presents recommendations based on the current profile information of the user “Carla Grant” (141) and the profile information of other users in the ESN platform, and/or the profile information of corresponding users in a public social network site (e.g., LinkedIn).

In FIG. 3, the dashboard (140) has three sections (150, 160 and 171). The first section (150) shows the recommended persons for social connection; the second section (160) shows the suggested searches tailored for the user “Carla Grant” (141); and the third section (171) indicates the number of suggested updates to the profile of the user “Carla Grant” (141). Each of the sections (150, 160 and 171) can be selected to access a detailed user interface for the respective recommendations. Further, the sections (150, 160) have user interface elements that allow the user “Carla Grant” (141) to interact with the dashboard (140) without leaving the dashboard (140) or the web page.

In the section (150) showing the recommended persons, the dashboard (140) shows a profile photo (143) of a recommended person (e.g., “Naomi Ang” (145)) and brief information about the recommended person, such as job title, resident city and state. The dashboard (140) shows the numbers of matches in explicit information in areas such as the number of common friends (151) shared between the recommended person “Naomi Ang” (145) and the user “Carla Grant” (141), the number of common groups (153) shared between the recommended person “Naomi Ang” (145) and the user “Carla Grant” (141), the number of common skills (155) shared between the recommended person “Naomi Ang” (145) and the user “Carla Grant” (141), etc.

Although the recommendation shows the matching of explicit profile information (e.g., friends, groups, skills, and others), the recommendation is powered also by implicit profile information that is derived from explicit profile information, where the implicit profile information is not shown to the users.

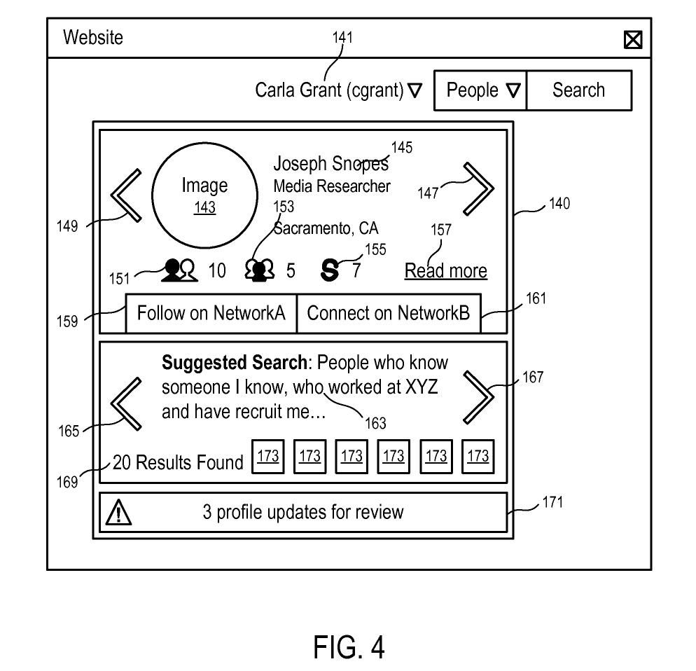

When there are multiple persons recommended by the system to the user (e.g., “Carla Grant” (141) illustrated in FIG. 3), the dashboard (140) shows a left arrow (149) and/or a right arrow (147), which can be selected by the user to view the recommendations one at a time, without leaving the dashboard (140). For example, in FIG. 3, one of the arrows in the person recommendation section can be selected to view the next recommended person, such as “Joseph Snopes” (145) illustrated in FIG. 4.

In FIG. 3, the user interface element “Read More” (157) is selectable to leave the dashboard (140) and request a detailed user interface (e.g., on a separate web page, or a window overlaid on the web page of the dashboard (140)) to view recommended users and suggested actions in relation with the recommended users.

In FIG. 3, the user interface element “Follow on NetworkA” (159) is selectable to request to follow the recommendee in the “NetworkA” (e.g., the ESN for the company) and thus receive posts and feeds from the recommendee.

In FIG. 3, the user interface element “Connect on NetworkB” (159) is selectable to initiate a request for a connection with the recommendee in the “NetworkB” (e.g., a public social network site, such as LinkedIn) and thus establish a “friend” relation with the recommendee in the “NetworkB”.

In the section (160) showing the recommended searches, the dashboard (140) shows a suggested set of search criteria that appear to be important to the user “Carla Grant” (141) and/or may provide meaningful results for the user “Carla Grant” (141). In FIG. 3, the recommended search corresponds to a sentence (163) of “People who know someone I know, who worked at XYZ and have recruited me . . . ”; and the expression of the recommended search in a sentence in a natural language in the section (160) allows the user to better understand and evaluate the suggestion.

When there are multiple searches recommended by the system to the user, the dashboard (140) shows a left arrow (165) and/or a right arrow (167), which can be selected by the user “Carla Grant” (145) to obtain the preview of the recommended searches one at a time, without leaving the dashboard.

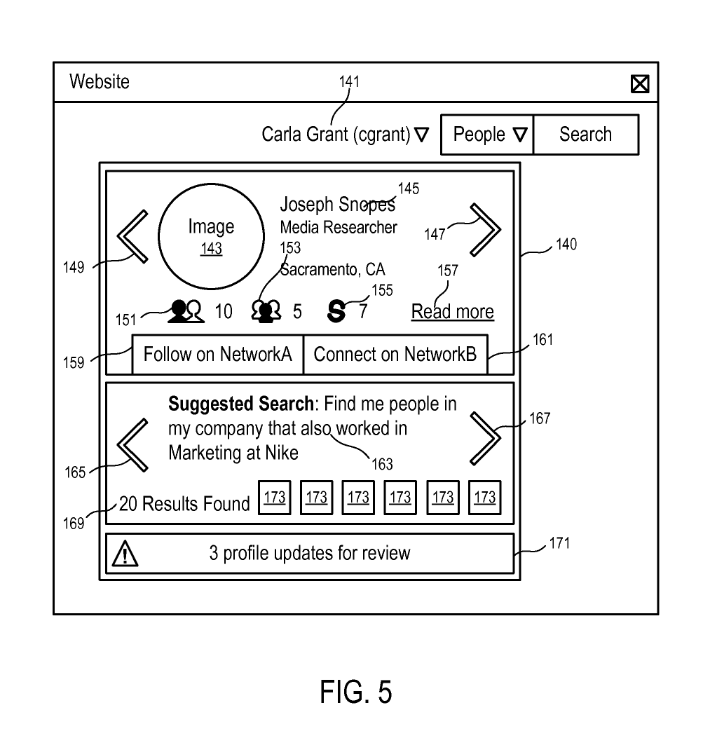

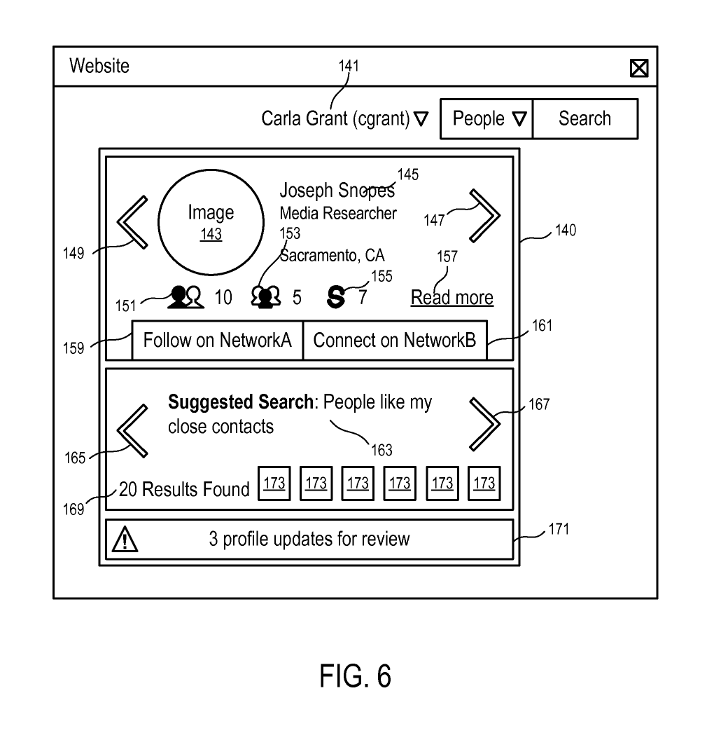

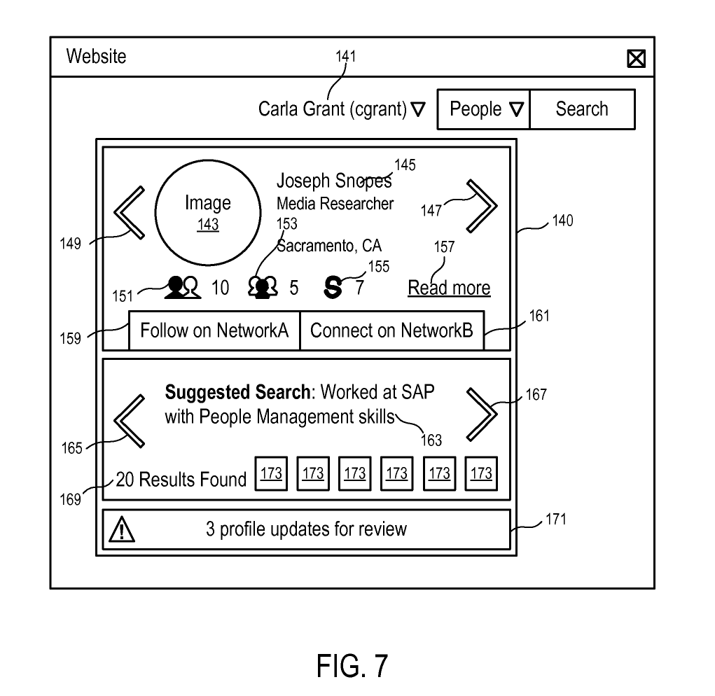

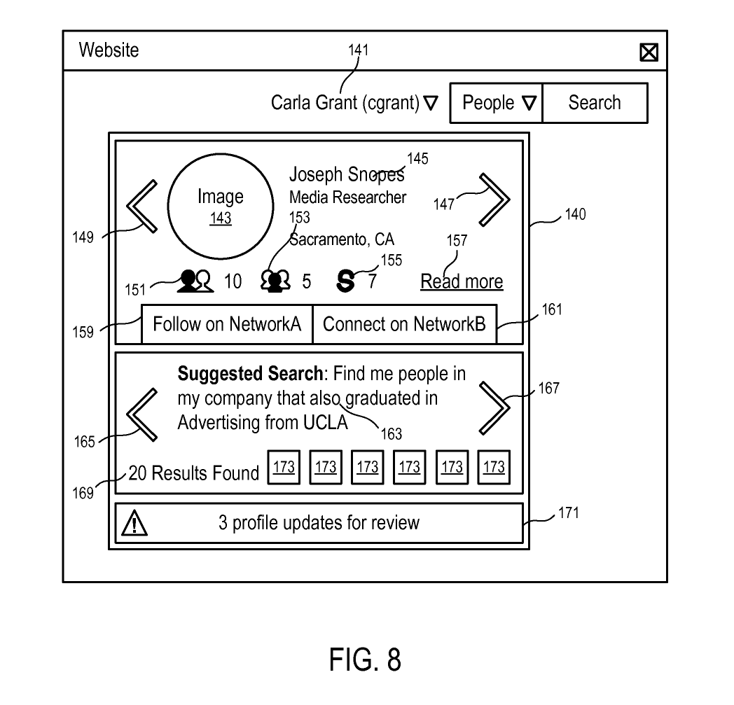

For example, in FIG. 4, one of the arrows (165, 167) in the search recommendation section (160) can be selected to view the next recommended search illustrated in FIG. 5 and further selected to view the recommended searches illustrated in FIGS. 6-8, such as a suggested search of “Find me people in my company that also worked in Marketing at Nike” in FIG. 5, a suggested search of “People like my close contacts” in FIG. 6, a suggested search of “Worked at SAP with People Management skills” in FIG. 7, a suggested search of “Find me people in my company that also graduated in Advertising from UCLA” in FIG. 8.

In FIG. 3, the search recommendation section (160) shows the number of search results (169) for the suggested search (163), and the photo images (173) of the persons in the search results of the suggested search (163). Each of the images (173) shows the profile photo of a different person in the search results.

In FIG. 3, each of the profile photo images (173) in the search recommendation section (160) is selectable to leave the dashboard (140) and request a detailed user interface (e.g., on a separate web page, or a window overlaid on the web page of the dashboard (140)) to process the result of the suggested search (163) and/or request different searches.

In FIG. 3, the people recommendation platform is implemented on a private ESN that maintains a profile of the user “Carla Grant” (141) specifically for the ESN. The people recommendation platform also obtains relevant profile information of the user “Carla Grant” (141) from a public social network (e.g., LinkedIn). When mismatches between the profile of the user “Carla Grant” (141) in the ESN and the profile of the user “Carla Grant” (141) in the public social network (and/or other information source) are detected, the dashboard shows an alert in the section (171) to update the ESN profile of the user.

In FIG. 3, the alert/section (171) presented in the dashboard (140) is selectable to the dashboard (140) and request a detailed user interface (e.g., on a separate web page, or a window overlaid on the web page of the dashboard (140)) to review, update, confirm, and/or verify the profile of the user “Carla Grant” (141) stored specifically for the ESN configured for the company.

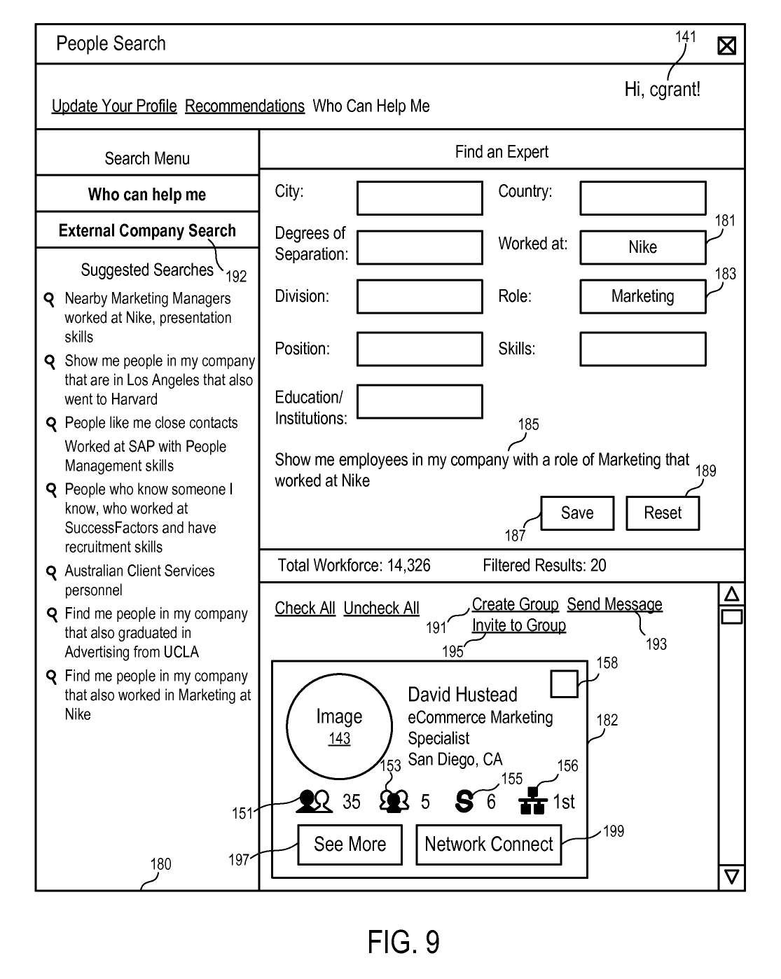

In one embodiment, when the recommended search section is selected, the user is provided with a search interface entitled “Who Can Help Me” illustrated in FIG. 9.

In FIG. 9, a list of suggested searches (e.g., “Nearby Marketing Managers worked at Nike, presentation skills”, . . . ) are provided in the left panel (180) in a form of a natural language. The user may click on one of the suggested searches to obtain persons recommended according to the clicked search criteria.

Alternatively, the user may provide search criteria in the entry boxes (e.g., 181, . . . , 183) in the area of “Find an Expert”. The user may specify search criteria in areas such as resident city, country, places previously worked at (181), current job role (183), skills, education, degrees of separation, division in a company, position in a company, etc.

In FIG. 9, the set of search criteria specified in the entry boxes (e.g., 181, . . . , 183) in the area of “Find an Expert” is formulated into a search request sentence (185) in a natural language. The user may select the user interface element “Save” (187) to save the set of search criteria corresponding to the search request sentence (185) for later use, or the user interface element “Reset” (189) to clear the search criteria from the entry boxes (181, . . . , 183).

In FIG. 9, the result panel shows a set of cards (e.g., 182) for the recommended persons in the search results. Each of the cards (e.g., 182) includes a profile image (143) of the recommended person, the name of the recommended person (e.g., “David Hustead”), the job title of the recommended person (e.g., “eCommerce Marketing Specialist”), and the location of the recommended person (e.g, the city and state of the residence of the recommended person).

Further, in FIG. 9, each of the cards (e.g., 182) includes the explicit profile matching information, such as the number of common friends (151) shared between the recommended person “David Hustead” (145) and the user “Carla Grant” having the user ID “cgrant” (141), the number of common groups (153) shared between the recommended person and the user, the number of common skills (155) shared between the recommended person and the user (141), the social network distance (156) in the form of degrees of separate, etc.

In FIG. 9, each of the cards (e.g., 182) includes a check box, that can be checked to indication the selection of a card from the search results. The user interface allows the user to select a set of cards (e.g., 182) via the check boxes of the cards, and request an operation on the group of selected recommendees corresponding to the selected set of cards, such as creating (191) a new group for the set of recommendees in the ESN, sending (193) a message to the selected set of recommendees, inviting (195) the selected recommendees to a group, etc.

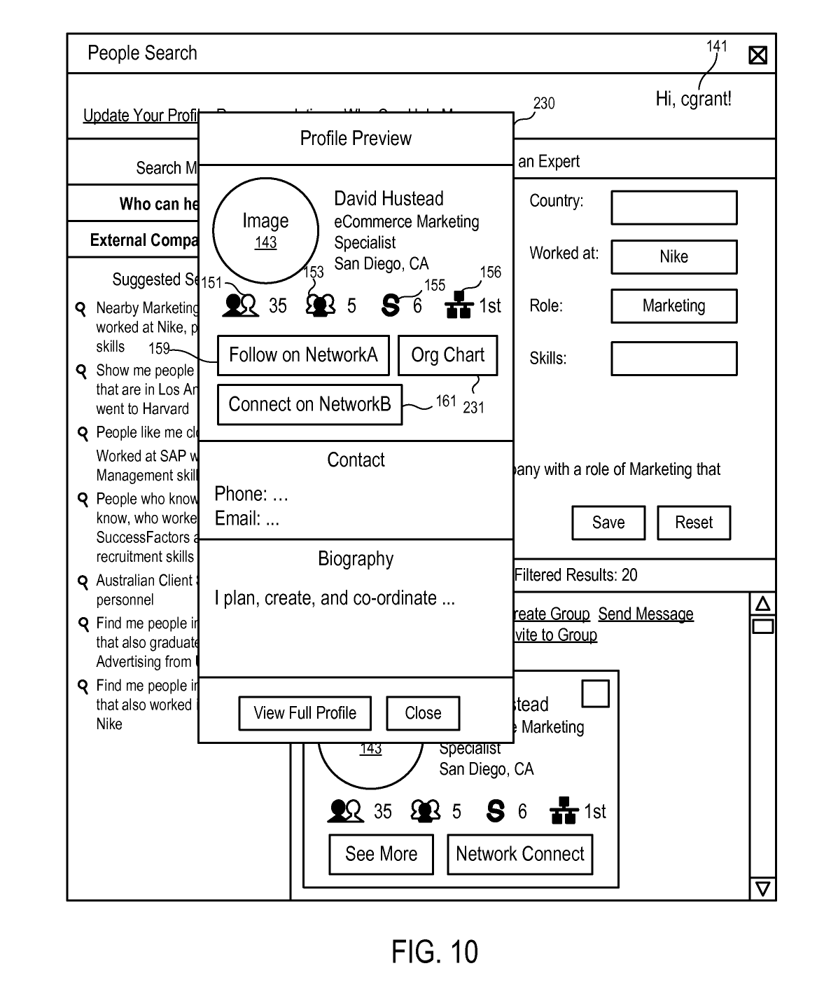

In FIG. 9, each recommended person (e.g., “David Hustead”) has a user interface element “see more” (197) button, which can be selected to obtain a profile preview interface (230) illustrated in FIG. 10.

In FIG. 10, the profile preview of the recommendee (e.g., “David Hustead”) includes the profile matching information, such as mutual friends (151), mutual groups (153), mutual skills (155), and degree of separation (156), and user interface elements to follow (159) the recommendee, to connect (161) with the recommendee, and to view the recommendee in an organization chart (231).

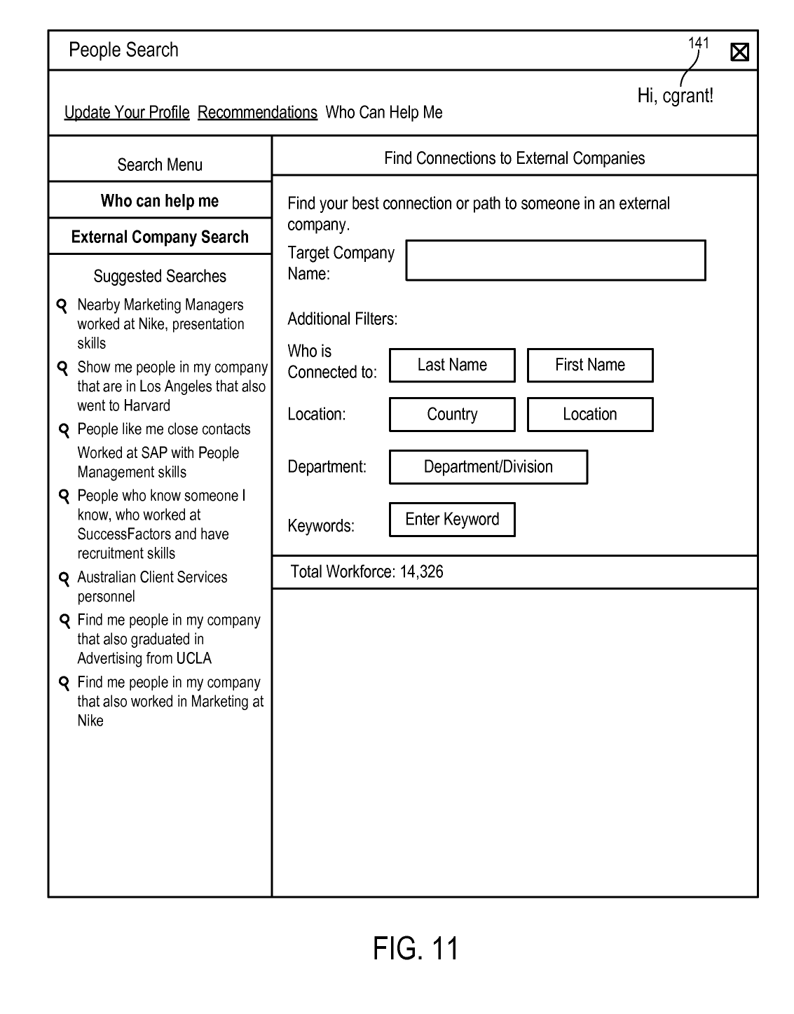

The “Who can Help Me” interface (e.g., as illustrated in FIG. 9) includes a user interface element “External Company Search” (192), which when selected leads to a search interface as illustrated in FIG. 11. When the External Company Search is conducted, the people recommendation platform does not use the explicit information that is provided in the ESN, but use the explicit information available in the public social network (e.g., LinkedIn) and the implicit information derived from the explicit information provided in the ESN.

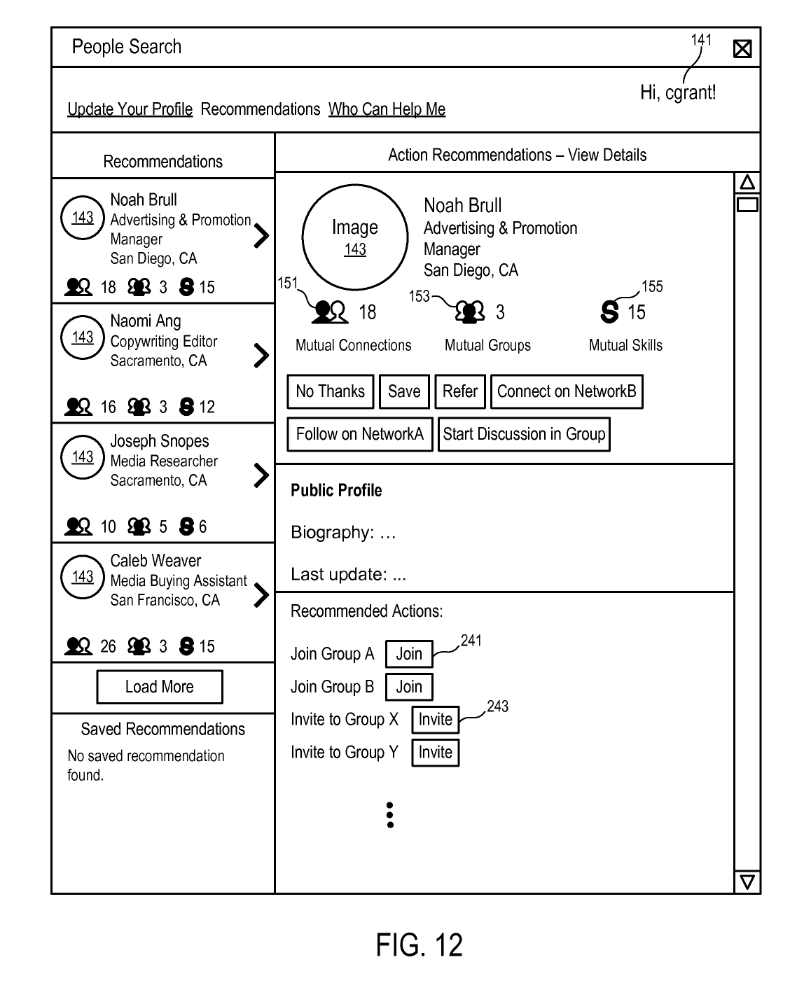

In one embodiment, when the person recommendation section (150) in the dashboard is selected, a “Recommendations” interface as illustrated in FIG. 12 is presented.

In FIG. 12, the interface shows the number of matched mutual connections (151), the number of matched mutual groups (153), the number of matched mutual skills (155), between the recommended person (e.g., “Noah Brull”) and the user (e.g., “Carla Grant” having the user ID “cgrant” (141)). The user interface provides public profile of the recommended person, and the recommended actions related to the user recommended person, as illustrated in FIG. 12.

For example, the user interface element (241) can be selected to join a particular group in which the recommendee (e.g., “Noah Brull”) is a member.

For example, the user interface element (243) can be selected to invite the recommendee (e.g., “Noah Brull”) to a particular group in which the user (e.g., Carla Grant” having the user ID “cgrant” (141)) is a member.

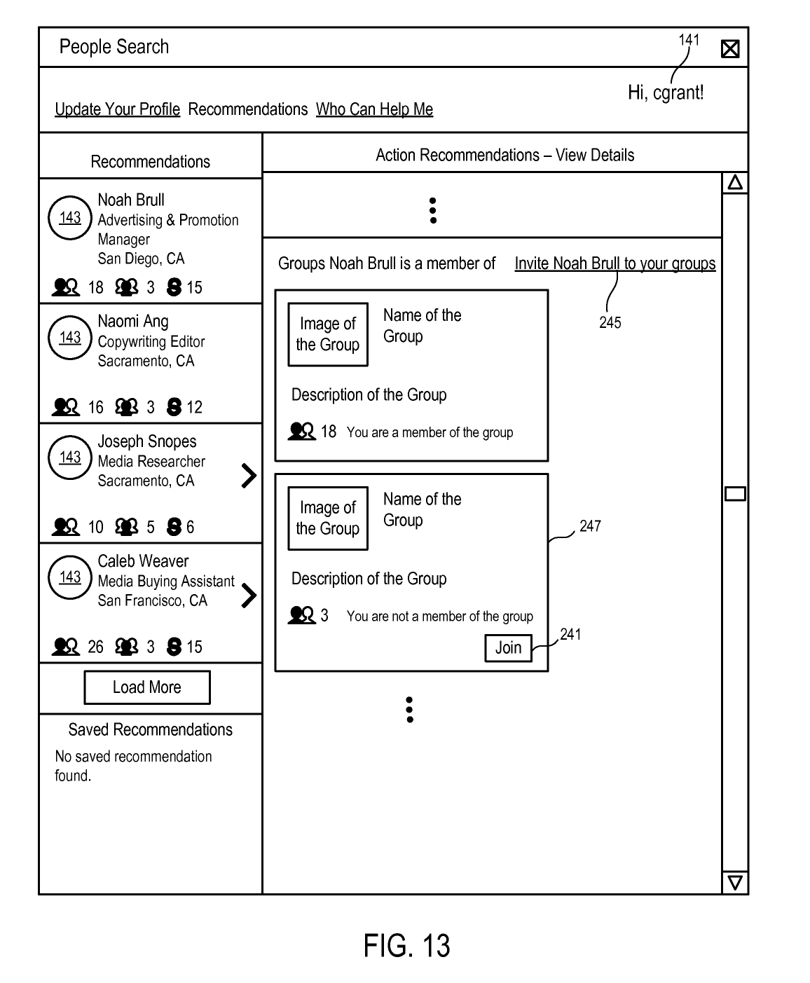

FIG. 13 shows the presentation of the groups in which the recommended person is a member. Each of the groups is presented in a form of a group card (e.g., 247) having an image of the group, the name of the group, a description of the group, the number of connections in the group (e.g., friends or direct connections) mutual/common to the user and recommendee, and an indication whether or not the user is a member of the group in which the recommendee is a member. If the user is not already a member of a particular group, the group card (e.g., 247) includes a user interface element (e.g., 241) to cause the user (e.g., Carla Grant” having the user ID “cgrant” (141)) to be invited to join the particular group in which the recommendee (e.g., “Noah Brull”) is a member.

In FIG. 13, the user interface element “Invite Noah Brull to your groups” (245) can be selected to view a similar set of group cards in which the user (e.g., Carla Grant” having the user ID “cgrant” (141)). Such group cards provide the indication of whether or not the recommendee (e.g., “Noah Brull”) is a member of the corresponding group, and if not, a user interface element (e.g., 243) selectable to invite the recommendee (e.g., “Noah Brull”) to the corresponding group.

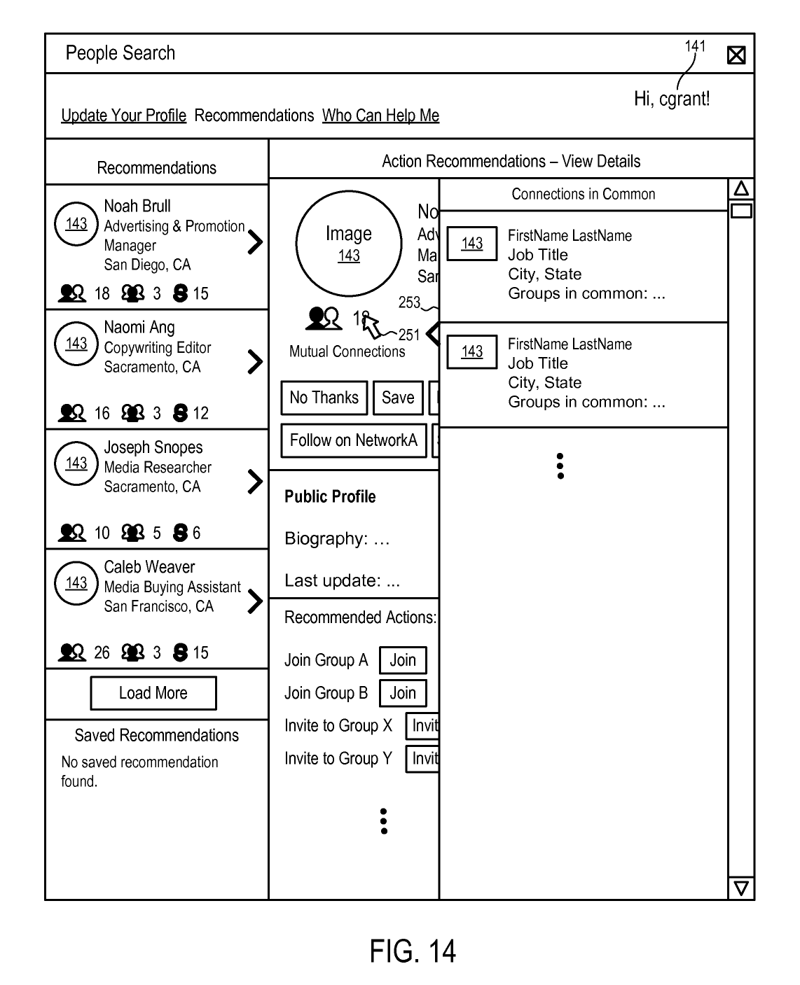

FIG. 14 shows a list (253) of connections in common between the user “cgrant” (141) and the recommendee “Noah Brull”, when the user positions the cursor (251) on the display of the number of the mutual connections.

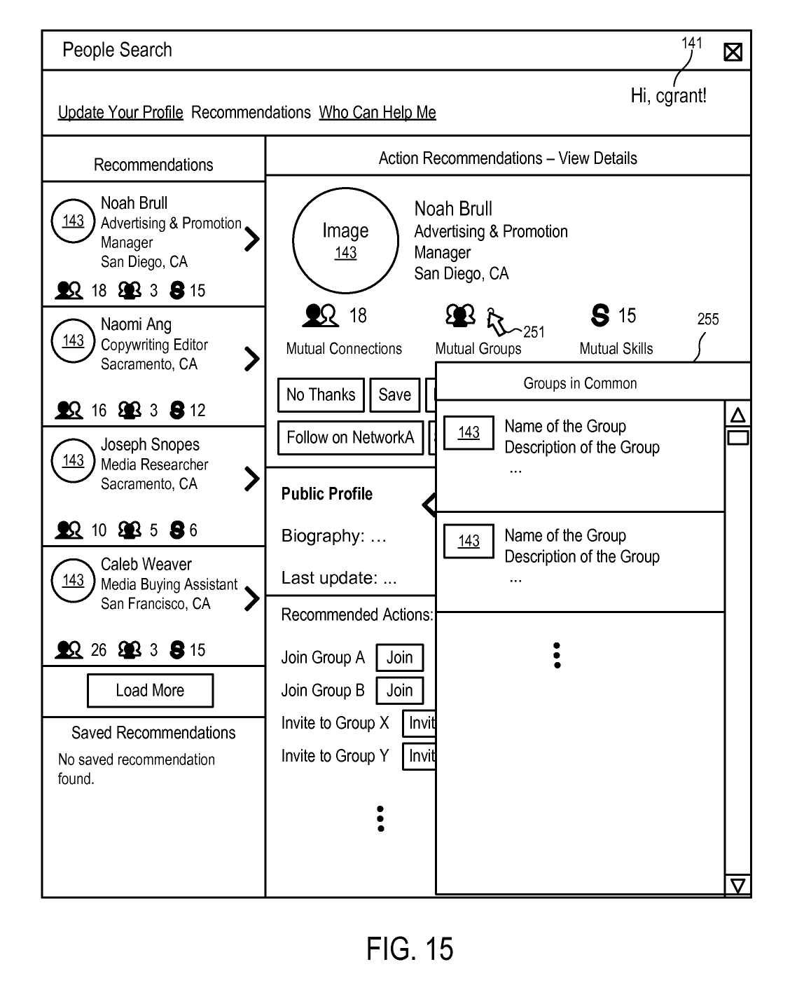

FIG. 15 shows a list (255) of groups in common between the user “cgrant” (141) and the recommendee “Noah Brull”, when the user positions the cursor (251) on the display of the number of the mutual groups.

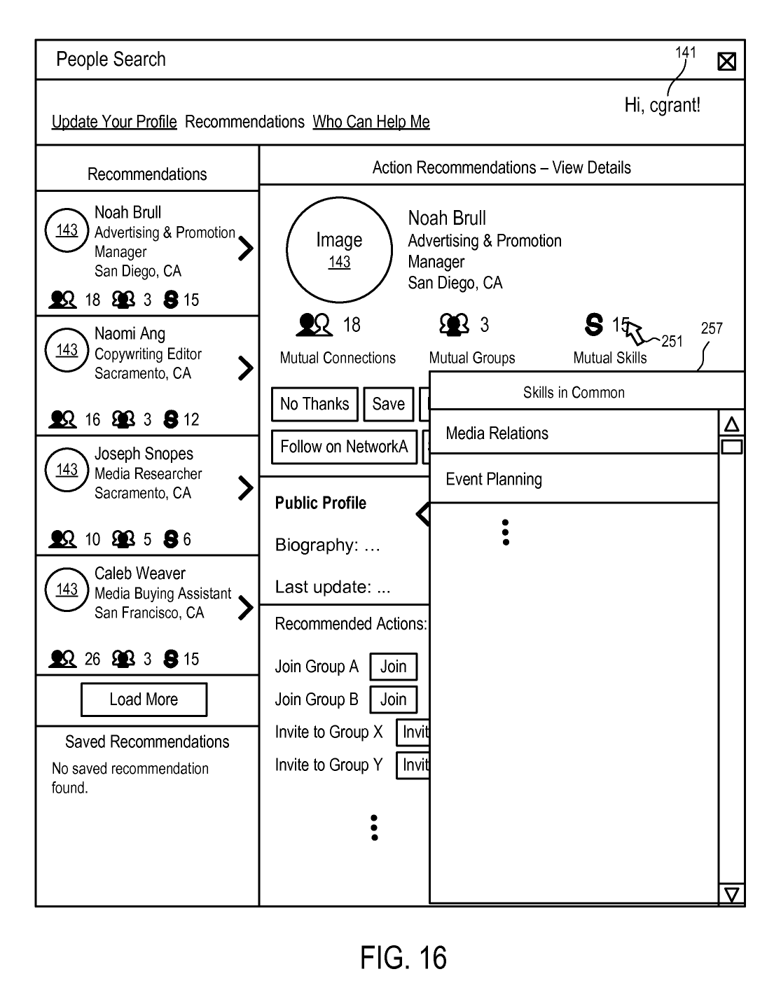

FIG. 16 shows a list (257) of skills in common between the user “cgrant” (141) and the recommendee “Noah Brull”, when the user positions the cursor (251) on the display of the number of the mutual skills.

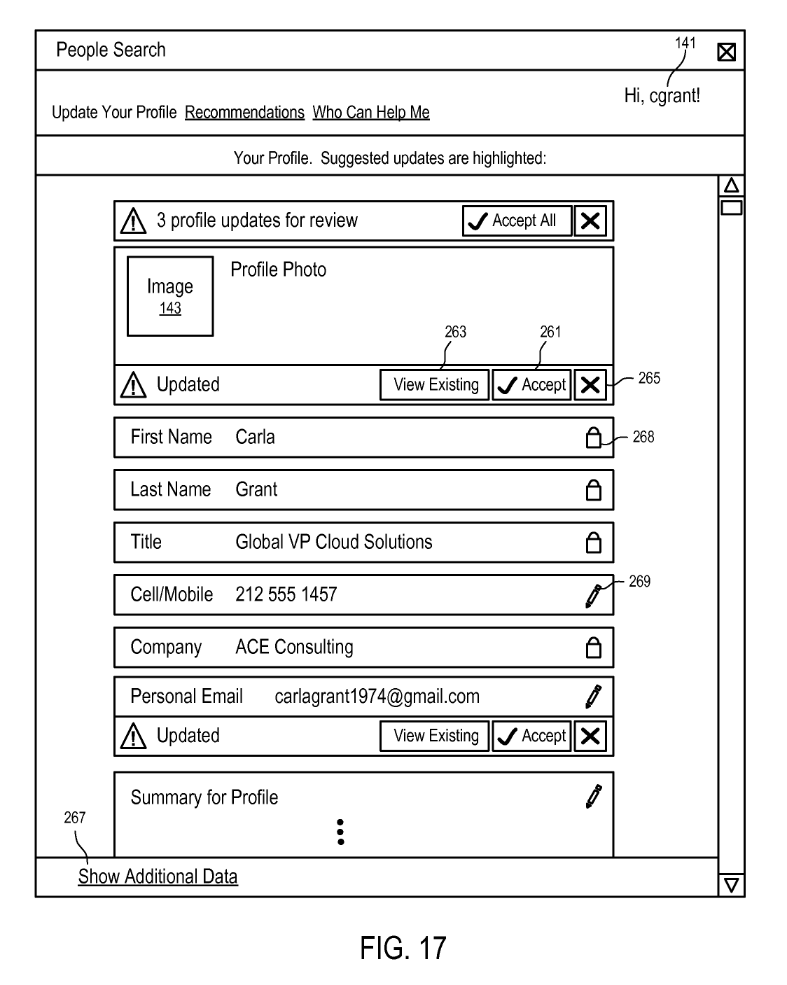

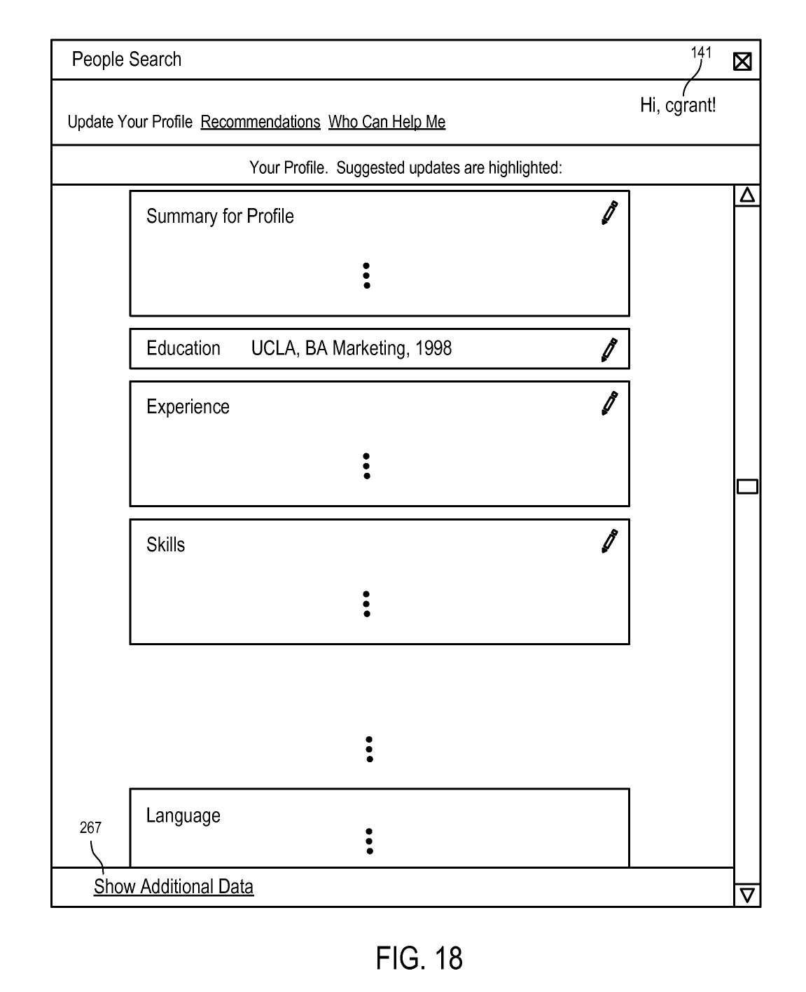

In one embodiment, when the profile update alert section (171) in the dashboard as illustrated in FIG. 3 is selected, a “Update Your Profile” interface as illustrated in FIGS. 17 and 18 is presented.

In one embodiment, the user interface in FIG. 17 presents the information obtained from other sources (e.g., a profile photo, or email address “carlagrant1974@gamil.com”) as an input candidate such that the user can simply click the corresponding user interface element “Accept” (e.g., 261) to use it in the profile of the user stored specifically for the ESN of the company.

In FIG. 17, the user interface element “View Existing” can be selected to view the existing element of the profile in the ESN; and the user interface element “reject” (265) can be selected to reject the suggestion of using the proposed element in the profile of the user stored specifically for the ESN of the company.

In FIGS. 17 and 18, the lock icon (e.g., 268) is used to indicate that the corresponding data field is locked in the ESN for the company; and the user lacks the privilege to edit the corresponding locked field. The edit icon (e.g., 269) is selectable to start an editing session of the corresponding field.

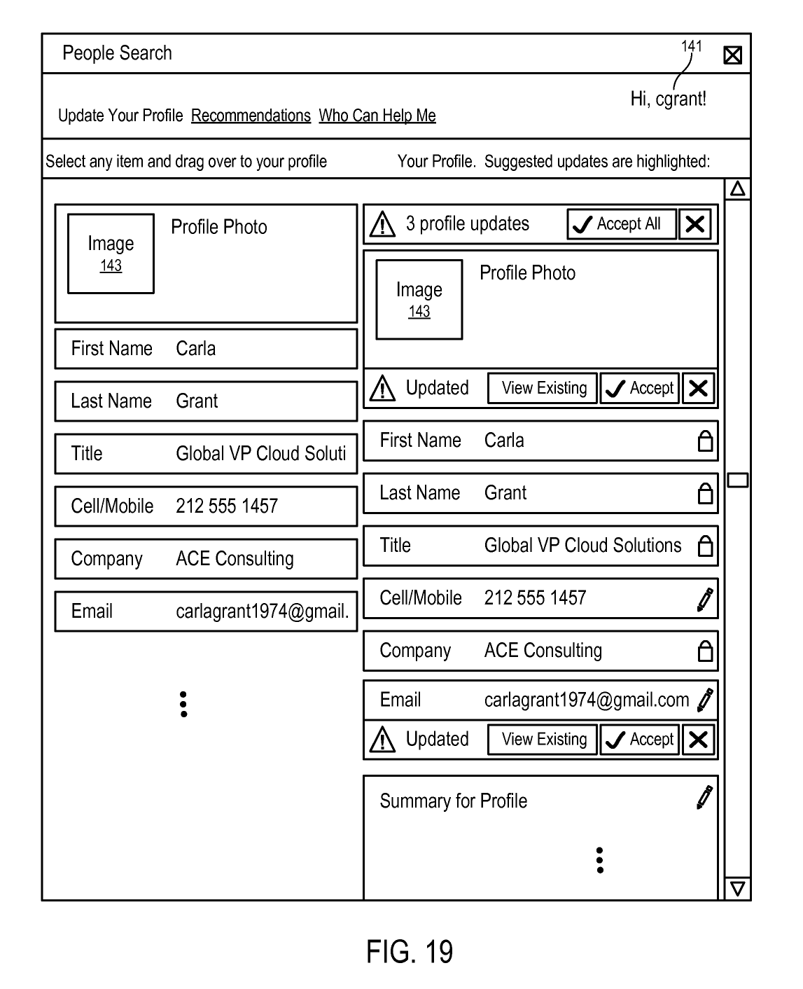

In one embodiment, when the “Show Additional Data” link (267) illustrated in FIGS. 17 and 18 can be selected to change the profile updating user interface into a format illustrated in FIG. 19. In FIG. 19, the corresponding profile information obtained from other sources (e.g., public social networking site) is presented at the left hand side, the suggested updates are presented on the right hand side for confirmation. The user can simply drag an item from the left hand side to the right hand side to request the update using the information from the left hand side.

In one embodiment, the user interface provides a way for a user to research a best way to connect to a recommended person.

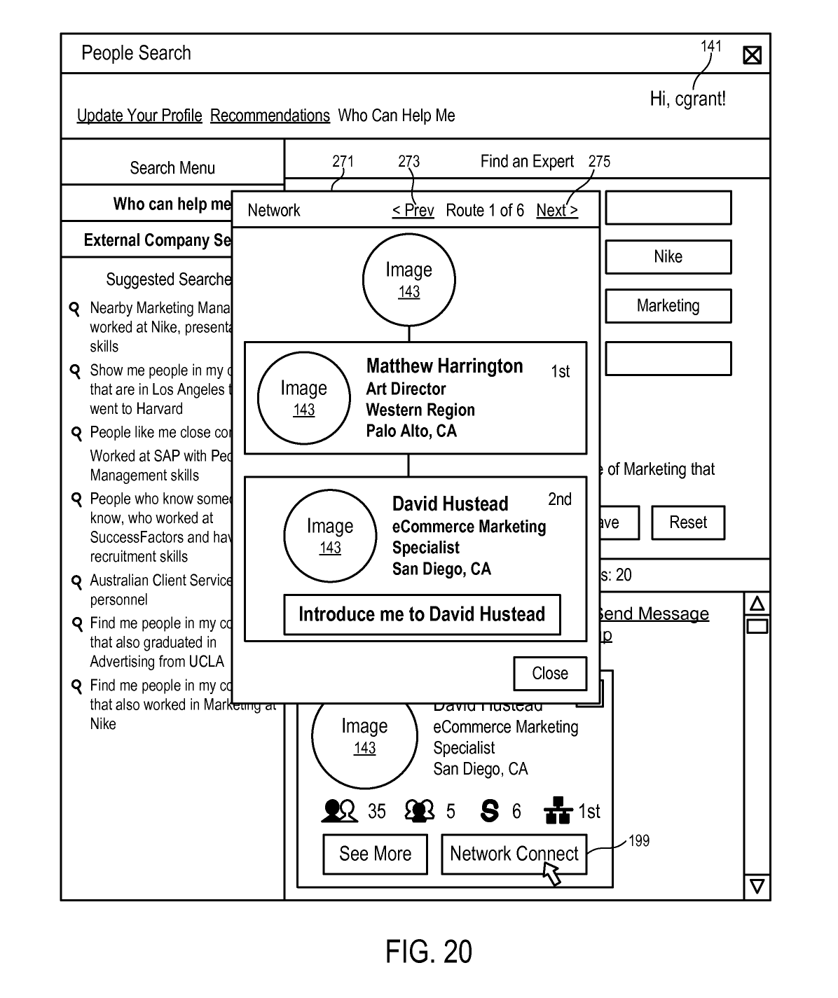

For example, in FIG. 9, a user interface element “Network Connect” (199) is presented for the recommended person (e.g., “David Hustead”). When the user interface element “Network Connect” (199) is selected, a user interface (271) as illustrated in FIG. 20 is presented.

In FIG. 20, the “Network” panel (271) shows a social network connection path between the user (e.g., “Carla Grant” having the user ID “cgrant” (141)) and the recommended person (e.g., “David Hustead”) via the mutual friend/connection (e.g., “Matthew Harrington”). The user interface elements “Prev” (273) and “Next” (275) are selectable by the user to cycle through different connection paths to identify a best way to be introduced to the recommended person.

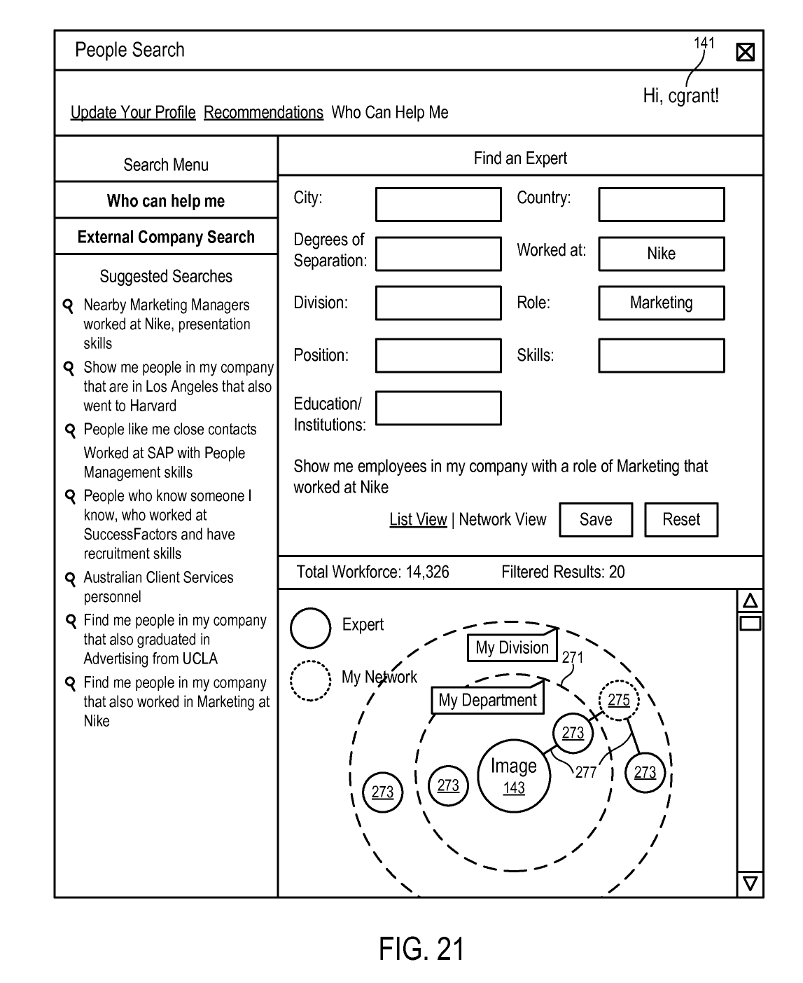

In one embodiment, the people recommendation platform is configured to present a network view of persons in the ESN (e.g., according to an organizational chart); and the connections between the recommended persons and the user are illustrated as linked nodes in the network view in FIG. 21.

In FIG. 21, the organization structure boundaries (e.g., department, division) of the user is represented by the boundary lines (e.g., 271), centered at the photo image (143) of the user. The photo images (273) of the experts in the search results and the photo images (275) of persons in the network of the user are presented in relation with the boundary lines (e.g., 271) of the organization structures, and the line segments (277) represent the direct connections of the experts and friends in their networks.

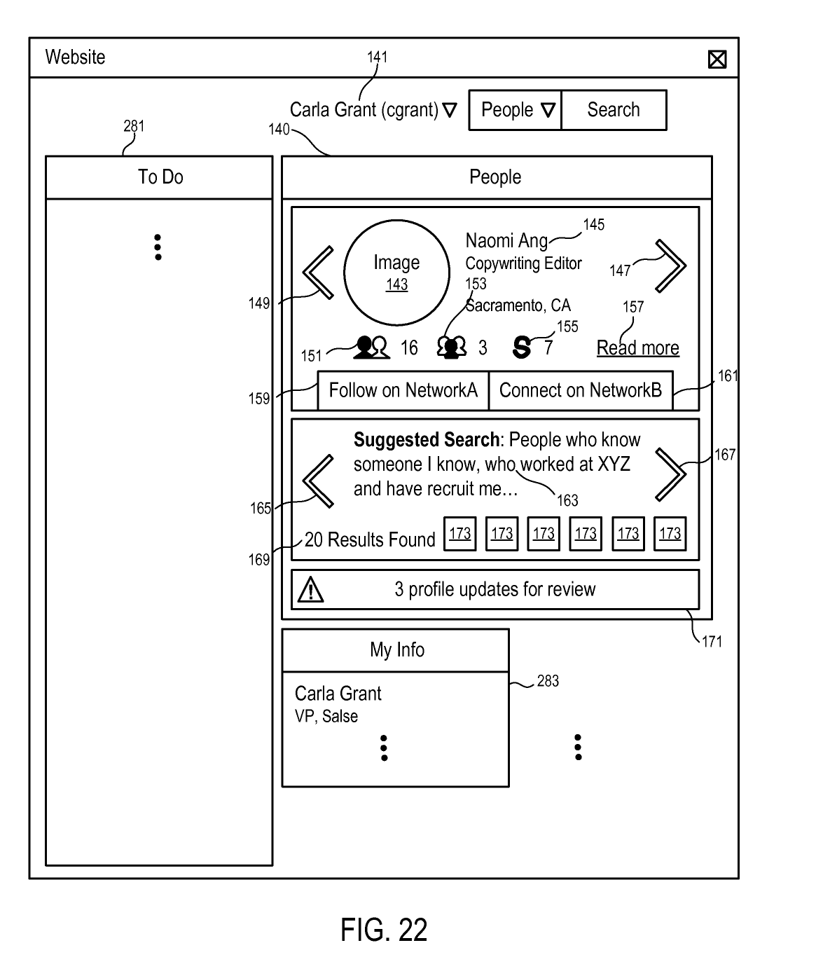

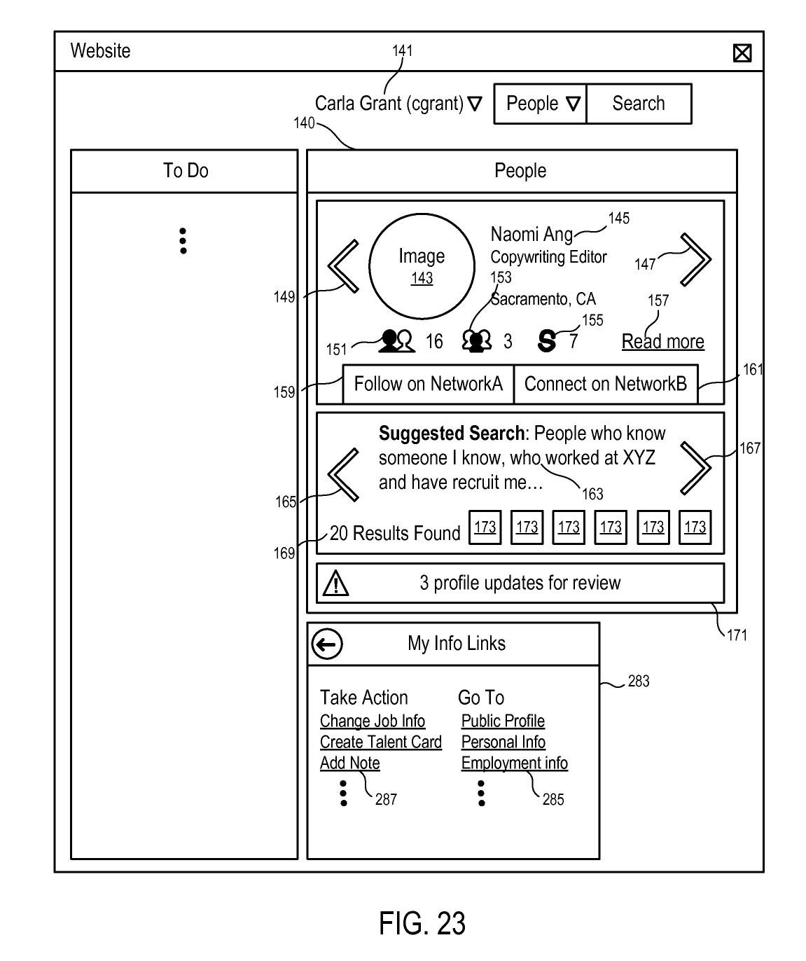

FIG. 22 shows an example of the dashboard (140) presented amount other panels of an ESN application, such as panel “To Do” (281), panel “My Info” (283), etc. In one embodiment, when the panel “My Info” (283) is selected, the panel (283) is updated to show a user interface as illustrated in FIG. 23 for actions associated with the profile of the user in the ESN.

FIG. 23 shows details of “My Info Links” (e.g., 285, . . . , 287), which can be selected to request the user interface to enter the profile information of the user in the ESN.

FIGS. 9, 21 and 24 show different user interfaces of the people recommendation platform configured to search for persons of interest within an enterprise/company represented by an ESN. The search tool provides enterprise wide intelligent on persons of interest.

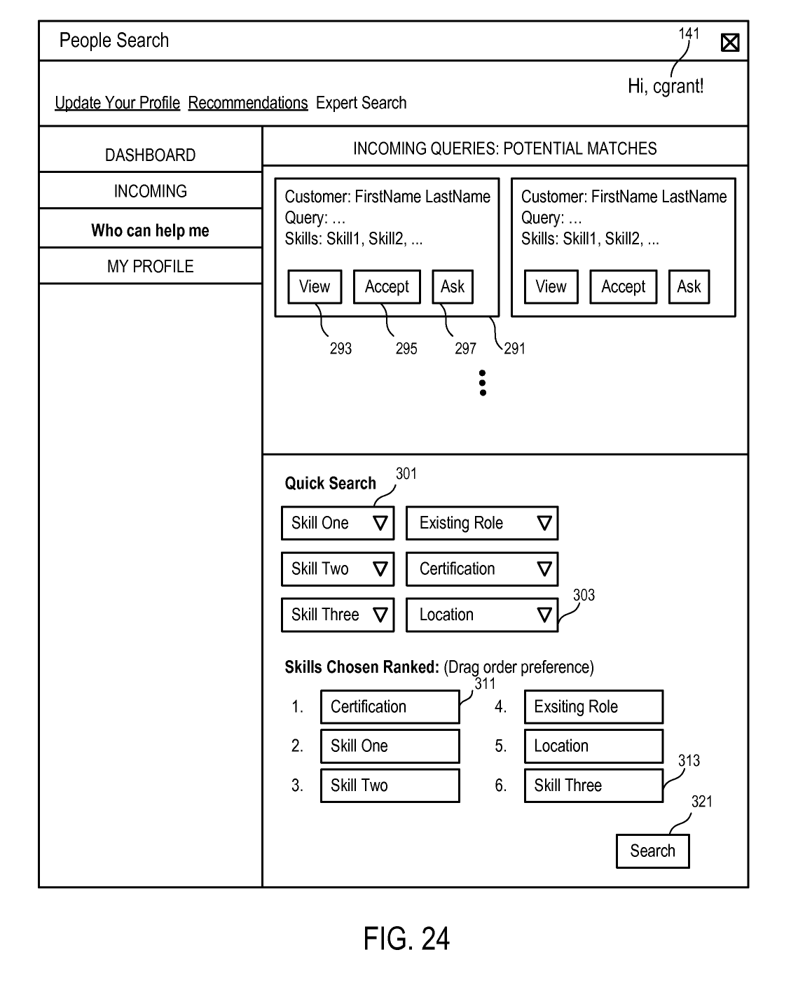

In one embodiment, instead of using the social feed of the internal social network to broadcast a question or posting a question into the ether, the people recommendation platform is configured to allow users to enter a free text question that needs answering. The search tool of the people recommendation platform then identifies potential employees who would likely have a view, some content, or the answer to the question and provides the question into their dashboard, as illustrated in FIG. 24, to accept and respond to, refer to someone more fitting or request more information.

In FIG. 24, each of the questions that were asked by others in the ESN and that are determined to be relevant to the user “cgrant” (141) is presented in a question panel (e.g., 291). The question panel (291) identifies the customer in the ESN who raised the quest by name, shows the question as a query in the form of a free text question, and list the skills relevant to the question (or other relevant information).

In one embodiment, the people search platform determines a match between the question and the users to whom the questions are presented (e.g., “cgrant” (141)) based at least in part on a matching score computed from matching the skills relevant to the question and the skills of the respective users. When the matching score between a question and a user (e.g., “cgrant” (141)) is above a threshold, the question is presented to the user in the dashboard as illustrated in FIG. 24; otherwise, the question is not presented to the user in the dashboard. In some embodiments, the matching score is further based on a profile matching between the customer who raised the question, and the user who may potentially answer the question.

In FIG. 23, the question panel (291) includes a user interface element “View” (293) selectable to view details about the question, the profile of the customer who raised the question, possible answers provided by others, and/or the profiles of those who provided answers to the question.

In FIG. 23, the question panel (291) includes a user interface element “Accept” (295) selectable to accept the challenge to answer the question, and a user interface element “Ask” (295) selectable to ask the customer some aspects related to the question raised by the customer.

In one embodiment, such the question tool receives a question from a user in the ESN as a customer, and searches for matching persons/users that may have the expertise to provide answers to the questions based on profile data, and present the matching persons to the customer and/or present the questions/customer to the matching persons.

In one embodiment, neither the person who asked the question nor the person who answered is identified to each other until a response to the question has been received in the system. Responses to questions can be marked as solved; and gamification & rewards can be added to motivate the workforce.

In one embodiment, a question from a user/customer is presented to the dashboard of the persons/users identified by the system via the search (e.g., based on matching the skill requirements of the question and the skills of the identified persons according to the profiles of the persons). Based on the presentation of the question, the user and/or the skills required for the question in the dashboard of a person identified by the system, the person may accept the question to establish a connection with the user, provide an answer, and/or ask a follow-up question for a discussion about the subject.

In one embodiment, the answer or follow-up question is present to the dashboard in of the user who initially raised the question; and the user is allowed to view the answer, ask a further question, and/or request a connection with the person who provided the answer or the follow-up question.

In FIG. 24, the user interface provides the user “cgrant” (141) with a quick search interface for people meeting a set of search criteria in user interface elements (301, . . . , 303). Each of the user interface elements (301, . . . , 303) are pre-configured to receive a criterion of a predetermined type (e.g., skill, existing role, certification, location). A corresponding set of elements (311, . . . , 313) shows the ranked priority of the set of search criteria in user interface elements (301, . . . , 303). In FIG. 24, the user is allowed to drag the elements (311, . . . , 313) to change the ranked order of the search criteria specified in user interface elements (301, . . . , 303).

In one embodiment, a user is provided with a user interface to ask questions and/or provide answers anonymously. For example, an employee of a company having an enterprise social network (ESN) configured with the system of the present application can ask the system a free-text question about a topic; and the people recommendation platform presents the question (e.g., anonymously without revealing the identity of the employee submitted the question) to the employee who either has the most relevant experience or access to the answer, as determined by the people recommendation platform, based on profile information and/or social networking information. The people recommendation platform is configured to allow the employee receiving the question to provide answer anonymously.

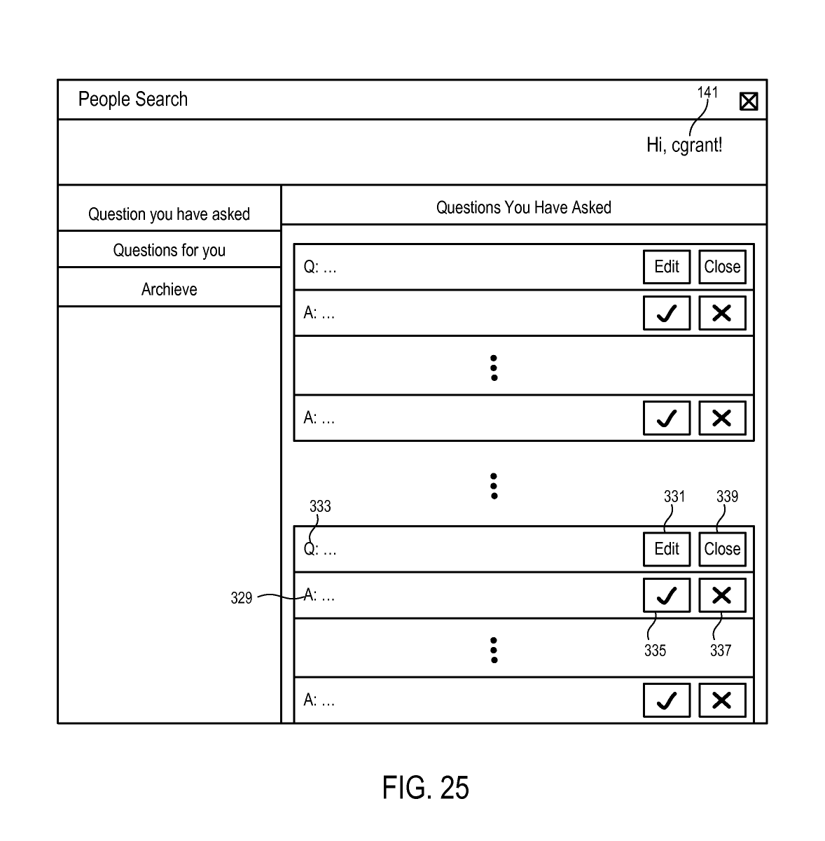

FIG. 25 shows a user interface to present the questions asked by a user “cgrant” (141) of the user interface and the answers received via the system for presentation to the user “cgrant” (141). The user interface element “Edit” (e.g., 331) is selectable by the user “cgrant” (141) to start an editing session of the corresponding question (333).

In FIG. 25, the user interface element “Accept” (e.g., 335) is selectable by the user “cgrant” (141) to accept the corresponding answer (e.g., 329) for the question from a plurality of answers collected by the people recommendation platform; and the user interface element “Reject” (e.g., 337) is selectable by the user “cgrant” (141) to reject the corresponding answer (e.g., 329) for the question from a plurality of answers collected by the people recommendation platform.

In FIG. 25, the user interface element “Close” (e.g., 339) is selectable by the user “cgrant” (141) to close a question for answering by other matching persons.

In one embodiment, the system is configured to present the questions and answers in an anonymous setting, preventing employees having to broadcast knowledge gaps, encouraging employee to ask, with full integration into learning platforms to create global catalog/universal database of questions and answers.

### Machine Learning Based Optimization of People Recommendation

One embodiment of the disclosure provides a machine learning, multi-variant people recommendation platform.

The people recommendation platform is not just about introducing ‘random’ people. People do not want to make cold connections with others: rather they seek points of commonality and introductions from people they know or know of.

The people recommendation platform is intelligent enough to make recommendations that will engender the same trust as if a friend introduced you by understanding the personal style of the user and thought process when contemplating a recommendation.

One of differentiators of the people recommendation platform is to train the user to start to engage with the mathematically perfect recommendation. The first recommendation is typically ‘human’: someone they know, who the user intuitively feels interested to connect with. Then, the people recommendation platform is configured via machine learning to edge the user towards the ‘smart’ recommendation: someone they don't know but who the people recommendation platform determines that they should look at and connect with. Machine learning can drive the people recommendation platform to get the workforce closer to the mathematically perfect recommendation.

In one embodiment, the people recommendation platform provides 3 intra and three extra recommendations to a user; and depending on which of those 3 the user first chooses, which choice could be a very subjective one, the people recommendation platform starts to understand him or her via machine learning. In one embodiment, multi-variant machine learning is applied to understand what deems to be important in a recommendation for the user; recognizing that the users' needs and habits change constantly, the people recommendation platform is configured to morph with those needs.

The inventors recognize that it is not the case that random people with no apparent connection do not have the information the user needs but rather that no one knows who has the answer until the question is asked and familiarity breeds inherent trust. That breeds a starting point for a conversation and ultimately it is the 2nd degree connections, friends of friends who are the most valuable and likely people a user will seek an answer from. People we don't already know can provide more value in the aggregate that your 1st degree connections because their network becomes your network and their peers and knowledge likely do not come from the same circles or influence as you first degree connections.

In one embodiment, the people recommendation platform is configured to start recommendation from selecting candidates from 1st degree connections (friends), use machine learning to train recommendation parameters based on user choices, and expend the recommendation to 2nd degree connections (friends of friends) while continuing training the recommendation parameters via machine learning.

In one embodiment, the people recommendation platform is configured to make the user click. It shows as much commonality as possible without discarding implicit data. This is the slow process of first placing recommendations that make logical sense to the user in front of him or her to engender trust then subsequently, slowly pushing in mathematically generated ‘best recommendations’ to train the user to explore. This is a per user algorithm using multi-variant testing to encourage a user to become familiar with looking at people: the people recommendation platform sees who they reach out to and use that data to reformulate their “type” of person they are likely to look at. This index score is two way process and is summarized as “is this user likely to message this person and is the person they are messaging likely to respond?” This technique is designed to train the user (and thus the system), almost in a game like fashion, to get them to the end result (that being their “best recommendation”) despite it not being the first one we display.

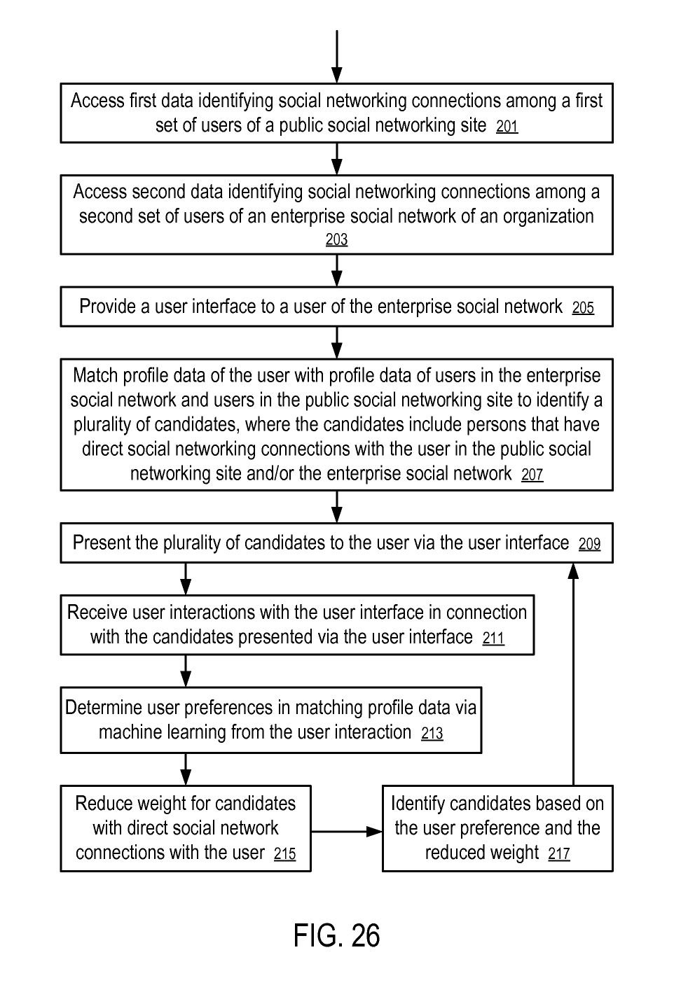

FIG. 26 shows a method to improve people recommendation according to one embodiment.

In FIG. 26, the people recommendation platform is configured to: access (201) first data identifying social networking connections among a first set of users of a public social networking site; access (203) second data identifying social networking connections among a second set of users of an enterprise social network of an organization; provide (205) a user interface to a user of the enterprise social network; match (207) profile data of the user with profile data of users in the enterprise social network and users in the public social networking site to identify a plurality of candidates, wherein the candidates include persons that have direct social networking connections with the user in the public social networking site and-or the enterprise social network; and present (209) the plurality of candidates to the user via the user interface.

In one embodiment, the people recommendation platform is configured to initially provide more weight to recommending candidates that are known to the user and thus have direct social networking connections with the user. The familiarity with the candidates allow the user to make selections that are indicative of the preferences of the user in seeking new social connections and thus allow the people recommendation platform to use machine learning techniques to extra the user preferences from the user selections.

For example, in FIG. 26, the people recommendation platform is further configured to: receive (211) user interactions with the user interface in connection with the candidates presented via the user interface; determine (213) user preferences in matching profile data via machine learning from the user interaction; reduce (215) weight for candidates with direct social network connections with the user; and identify (217) candidates based on the user preference and the reduced weight.

The updated candidates are presented in the user interface that receives further user interactions that are be user to further train the system via machine learning techniques.

For example, in one embodiment, the identification of candidates is based on the matching of a plurality of profile attributes. The profile attributes may include explicit profile data and implicit (hidden) profile data that are derived from explicit profile data via rule engines. In general, different matching profile attributes may be assigned different weights. The system may initially assign the same weight to the matching profile attributes. When a user selects a recommended candidate for social network connection, the system may adjust the weights of the profile attributes to increase the matching score of the user selected candidates. Thus, using a machine learning technique, such as a multi-variant machine learning technique, can be used to learn the user preference, e.g., in terms of the weight of the profile attributes, from the arrangement of providing candidates and receiving user interactions with the recommended candidates.

In one embodiment, the system is configured to start the machine learning process with the recommendation of the friends of the users. The familiarity of the user with the friends allows the user to make choices that meet the needs of the user. After the system learns the user preferences from the exercises with the recommendation of friends, the system can apply the user preferences to the recommendation of friends of friends.

In one aspect, an embodiment of the present application provides a user interface presented within a panel of an enterprise social network application of a user, including a first section of users recommended for social connections with the user, a second section of searches recommended for identifying users of interest to the user, and a third section of an alert for potential updates to the profile of the user in the enterprise social network application, based on information about user obtained from other information source, such as a public social networking site.

In another aspect, an embodiment of the present application provides a machine learning, multi-variant people recommendation platform configured to initially recommend friends of a user to the user, receive user interactions with the recommendation, use the user interaction in a machine learning engine to derive the user preferences in seeking social connections, and apply the derived user preferences to the recommendation of friends of friends of the user for establishing direct social connection with the user.

In a further aspect, an embodiment of the present application provides a people recommendation platform configured to augment explicit profile information obtained from a private community (e.g., a enterprise social network) with explicit profile information from a publication social networking site. Implicit profile information of the users are generated from analysis of the explicit profile information. The explicit profile information and implicit profile information of different users are matched with each other to determine matching scores, which are used to identify candidates for recommendations. When determining whether or not to recommend a person outside the private community to a person inside the private community, the platform does not match the explicit private profile data from the private community, but uses the implicit profile information derived from the explicit private profile data from the private community in matching.

In one embodiment, a method provided in the present application includes: accessing, by a computing apparatus, profile data of users in a private enterprise social network of a business and profile data of the users in at least one public social network for users from a plurality of businesses; identifying, by the computing apparatus, one or more updates to a profile of a first user in the private enterprise social network, based on the profile data of the users in the at least one public social network; analyzing, by the computing apparatus, the profile data of the users in the private enterprise social network of the business and the profile data of the users in at least one public social network to identify a plurality of second users recommended for establishing social connections with the user; data mining, by the computing apparatus, the profile data of the users in the private enterprise social network of the business and the profile data of the users in at least one public social network to identify one or more people searches for the first user; after the first user signing into the private enterprise social network, presenting by the computing apparatus a single first user interface among a plurality of second user interfaces of the of the private enterprise social network, the first user interface including: a first section to present the second users one at a time; and a second section to present the one or more people searches one at a time. The first user interface may further include a third section to alert the first user about the one or more updates. In response to the first user selecting a recommended user for establishing a direct social connection between the first user the recommended user, the people recommendation platform presents a third user interface to show a plurality of social paths for the first user to socially connect with the recommended user via mutual friends. For example, the plurality of social paths are presented in the third user interface one at a time, with a graphic representation of a social networking path from the first user to the recommended user connected via a friend of the first user.

In one embodiment, a method provided in the present application includes: matching, by a computing apparatus, profile attributes of a user to profile attributes of a plurality of users; generating, by the computing apparatus, matching scores based the matching of profile attributes and weights of profile attributes towards the matching scores; selecting, by the computing apparatus, a plurality of candidates based on the matching scores; presenting, by the computing apparatus, the candidates in a user interface; receiving, by the computing apparatus, input from the user interacting with presentation of the candidates; adjusting, by the computing apparatus, the weights of profile attributes based on the input in accordance with a machine learning technique; and updating, the computing apparatus, candidates presented in the user interface to receive further inputs to adjust the weights of profile attributes. The computing apparatus starts with selecting candidates from friends of the user and transits to selecting candidates from friends of friends of the user after training the weights of profile attributes. During the iterations of machine learning to train the weights of profile attributes, the computer apparatus reduces weights assigned to friends of the user and increases weights assigned to friends of friends of the user. For example, the plurality of users are identified from a public social networking site and an enterprise social network; and user interaction with recommended friends in the social networking site are used to train profile weights for recommending friends of friends in the enterprise social network.

In one embodiment, a method provided in the present application includes: receiving, in a computing apparatus, data about a community of users; determining, by the computing apparatus from the data, the users of the community, relations among the plurality of users in a social network, and first information about the plurality of users explicitly specified in the data about the community; receiving, in the computing apparatus, profile input from the users identifying second information about the users in the community; applying, by the computing apparatus, a set of rules to the first and second information about the plurality of users to identify third information about plurality of users, wherein the third information is not presented to the users for verification; determining, by the computing apparatus using the first, second and third information, matching scores for recommending the users in the social network to other users in the social network, wherein a matching score for recommending a first user to a second user is different from a matching score for recommending the second user to the first user; and determining, by the computing apparatus, whether to recommend the first user to the second user based on both the matching score for recommending the first user to the second user and the matching score for recommending the second user to the first user. For example, the data about the community of users is based on a private enterprise social network; and the method may further comprise: extracting profile information from a public social networking site; and augmenting the first and second information about the users using the profile information extracted from the public social networking site. For example, when the first user is in the private enterprise social network and the second user is not in the private enterprise social network, the computing apparatus is configured to ignore explicit data obtained from the private enterprise social network, while using the implicit data derived from the explicit data obtained from the private enterprise social network in determining whether or not to recommend the second user to the first user.

Embodiments provided in the disclosure include non-transitory computer medium storing instructions configured to instruct a computing apparatus to perform any of the methods disclosed herein and computing apparatuses having at least one microprocessor and memory storing the instructions.

### Data Processing Implementation

The systems and methods disclosed above are implemented in a computer apparatus in the form of a data processing system.

For example, the user devices (101) can be implemented as a data processing system, such as a portable computer, a personal computer, a notebook computer, a tablet computer, a mobile phone, a personal media player, a personal digital assistant, etc.

For example, the portal (103) and/or the database (107) can be implemented via one or more data processing systems, such as a cluster of server computers.

For example, the rule engine (121), the score engine (123), the recommendation engine (127) can be implemented via one or more data processing system, such as a server computer, a section of a server farm, or the use of the service of a computer cloud.

FIG. 2 illustrates a data processing system according to one embodiment. While FIG. 2 illustrates various components of a computer system, it is not intended to represent any particular architecture or manner of interconnecting the components. One embodiment may use other systems that have fewer or more components than those shown in FIG. 2.

In FIG. 2, the data processing system (130) includes an inter-connect (131) (e.g., bus and system core logic), which interconnects one or more microprocessors (133) and memory (134). The microprocessor (133) is coupled to cache memory (139) in the example of FIG. 2.

In one embodiment, the inter-connect (131) interconnects the microprocessor(s) (133) and the memory (134) together and also interconnects them to input/output (I/O) device(s) (135) via I/O controller(s) (137). I/O devices (135) may include a display device and/or peripheral devices, such as mice, keyboards, modems, network interfaces, printers, scanners, video cameras and other devices known in the art. In one embodiment, when the data processing system is a server system, some of the I/O devices (135), such as touch screens, printers, scanners, mice, and/or keyboards, are optional.

In one embodiment, the inter-connect (131) includes one or more buses connected to one another through various bridges, controllers and/or adapters. In one embodiment the I/O controllers (137) include a USB (Universal Serial Bus) adapter for controlling USB peripherals, and/or an IEEE-1394 bus adapter for controlling IEEE-1394 peripherals.

In one embodiment, the memory (134) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer system, comprising:
a graphical user interface having a dashboard for people recommendation to a first user of the graphical user interface, the dashboard comprising:
a first section presenting a plurality of second users one at a time, the first section including:
a first area showing a profile image of a corresponding user in the second users;
a second area showing profile text information of the corresponding user;
a third area showing profile matching information between the corresponding user and the first user; and
at least one first user interface element selectable to change a selection of the corresponding user from the second users; and
a second section presenting a plurality of people searches one at time, the second section including:
a fourth area showing a corresponding search in the plurality of people searches; and
at least one second user interface element selectable to change a selection of the corresponding search from the plurality of people searches.

2. The computer system of claim 1, wherein the fourth area of the second section shows the corresponding search in a form of a sentence of a natural language.

3. The computer system of claim 2, wherein the second section further comprises a fifth area showing a count of persons found in search results of the corresponding search.

4. The computer system of claim 3, wherein the second section further comprises a sixth area showing up to a predetermined number of profile images of the persons found in the search results.

5. The computer system of claim 1, wherein the profile matching information shown in the third area includes:
a count of social network connections to friends mutual to the first user and the corresponding user;
a count of groups in which both the first user and the corresponding user are members; and
a count of common skills found in profiles of both the first user and the corresponding user.

6. The computer system of claim 1, wherein the dashboard further comprises:
a third section identifying a number of suggested updates to a profile of the first user in a first social network according to data in at least a second social network.

7. The computer system of claim 6, wherein the first social network is an enterprise social network with access configured for employees in a private company; the second social network has users that are not limited to the private company.

8. The computer system of claim 6, wherein the first section further includes a user interface selectable to request a connection between the first user and the corresponding user in the second social network.

9. The computer system of claim 6, wherein the first section further includes a user interface selectable to submit a follow request in the first social network for the first user to follow the corresponding user and thus receive postings of the corresponding user in the first social network.

10. The computer system of claim 6, wherein the third section is selectable to request a profile updating user interface.

11. The computer system of claim 10, wherein the profile updating user interface presents, for each field of the profile to be update:
suggested content for the field, the suggested content obtained from the second social network;
a first user interface element selectable to accept the suggested content into the field of the profile of the user in the first social network; and
a second user interface element selectable to reject the suggested content for the field.

12. The computer system of claim 6, wherein the first section is selectable to request an action recommendation user interface in connection with the corresponding user presented in the first section.

13. The computer system of claim 12, wherein the action recommendation user interface identifies a group in which the corresponding user is a member but the first user is not a member and a user interface element selectable to join the group.

14. The computer system of claim 12, wherein the action recommendation user interface identifies a group in which the corresponding user is not a member but the first user is a member and a user interface element selectable to invite the corresponding user to join the group.

15. The computer system of claim 6, wherein the second section is selectable to request a people search user interface.

16. The computer system of claim 15, wherein the people search user interface presents each respective user found in a search in a panel having:
a first area showing a profile image of the respective user;
a second area showing profile text information of the respective user;
a third area showing profile matching information between the respective user and the first user;
a user interface element to request a view of the profile of the respective user; and
a user interface element to request a user interface to display alternative social network connection paths between the first user and the respective user.

17. The computer system of claim 16, wherein the alternative social network connection paths are presented one at a time, with a user interface element selectable to request introduction of the first user to the respective user via a selected social network connection path.

18. A method, comprising:
providing a graphical user interface having a dashboard for people recommendation to a first user of the graphical user interface, the dashboard comprising:
a first section presenting a plurality of second users one at a time, the first section including:
a first area showing a profile image of a corresponding user in the second users;
a second area showing profile text information of the corresponding user;
a third area showing profile matching information between the corresponding user and the first user; and
at least one first user interface element selectable to change a selection of the corresponding user from the second users; and
a second section presenting a plurality of people searches one at time, the second section including:
a fourth area showing a corresponding search in the plurality of people searches; and
at least one second user interface element selectable to change a selection of the corresponding search from the plurality of people searches.

19. The method of claim 18, wherein the dashboard is presented within an area of a web page in a first social networking site; and the dashboard further comprises:
a third section identifying a number of suggested updates to a profile of the first user in the first social network according to data in at least a second social network.

20. A non-transitory computer storage medium storing instructions configured to instruct a computing apparatus to perform a method, the method comprising:
providing a graphical user interface having a dashboard for people recommendation to a first user of the graphical user interface, the dashboard comprising:
a first section presenting a plurality of second users one at a time, the first section including:
a first area showing a profile image of a corresponding user in the second users;
a second area showing profile text information of the corresponding user;
a third area showing profile matching information between the corresponding user and the first user; and
at least one first user interface element selectable to change a selection of the corresponding user from the second users; and
a second section presenting a plurality of people searches one at time, the second section including:
a fourth area showing a corresponding search in the plurality of people searches; and
at least one second user interface element selectable to change a selection of the corresponding search from the plurality of people searches.
